(19) United States
(12) Patent Application Publication
(10) Pub. No.: US 2008/0172214 A1
(43) Pub. Date: Jul. 17, 2008

(54) System For Optimizing Treatment Strategies Using a Patient-Specific Rating System

(75) Inventors: Nananda F. Col, Worcester, MA (US); Griffin Weber, Boston, MA (US)

Correspondence Address: NORMA E HENDERSON;HENDERSON PATENT LAW, 13 JEFFERSON DR, LONDONDERRY, NH, 03053, US

(73) Assignee: Strategic Health Decisions, Inc., Worcester, MA (US)

(21) Appl. No.: 11/661,467

(22) PCT Filed: Aug. 26, 2005
(86) PCT No.: PCT/US2005/030316

§ 371 Date: Feb. 26, 2007

Related U.S. Application Data
(60) Provisional application No. 60/604,768, filed on Aug. 26, 2004.

(51) Int. Cl. G06G 7/48; G06G 7/58; G06Q 50/00

(52) U.S. Cl. 703/11; 705/3

(57) ABSTRACT

The combined effects of a selected treatment option on multiple causes of morbidity or mortality are simulated for evaluation. Various patient-specific and model-specific parameters, including parameters related to diseases to be modeled, are used in modeling incidence and mortality rates for each disease. These disease-specific models are used for defining a set of health states having initial probabilities, which are used to formulate a transition matrix used in matrix calculation to obtain output matrix Q. If additional cycles are needed, the transition matrix is updated and matrix calculation is performed using the updated transition matrix. Otherwise, final output matrix Q is utilized for calculation of values needed for determining an overall treatment score. The calculated values and/or values from Q are combined with patient or numeric scores from other treatment choice-related domains to obtain a raw score that is used to produce a patient-specific score for a selected treatment option.

### RELATED APPLICATION

This application claims priority to U.S. Provisional Application Ser. No. U.S. 60/604,768, filed Aug. 26, 2004, which is herein incorporated by reference in its entirety.

### REFERENCE TO A COMPUTER PROGRAM LISTING APPENDIX SUBMITTED ON A COMPACT DISC

This application contains a computer program listing appendix submitted on compact disc under the provisions of 37 CFR 1.96 and herein incorporated by reference. The machine format of this compact disc is IBM-PC and the operating system compatibility is Microsoft Windows. The computer program listing appendix includes, in ASCII format, the files listed in Table 1:

TABLE 1

| File name | Creation Date | Size in bytes |
|---|---|---|
| default.asp.txt | 8/11/2005 | 49,331 |
| dInfo.pm.txt | 12/12/2004 | 17,426 |
| markov.pl.txt | 8/11/2005 | 36,983 |
| mTable.pm.txt | 12/8/2003 | 59,759 |

### FIELD OF THE INVENTION

This invention relates to modeling methodologies and, in particular, to modeling of risk assessments for medical decisions involving multiple independent diseases and possible clinical outcomes.

### BACKGROUND

Risk models for individual diseases, such as the Framingham Heart Study for cardiovascular disease or the Gail Model for breast cancer, are well defined. However, patients are often faced with multiple comorbidities. To predict the future health of these patients, the risk models for each of the diseases must be combined. Unfortunately, the complex interactions between diseases and the long-term effects of treatments are often not well understood and therefore are difficult to model.

In order to model multiple comorbidities, several simplifying assumptions are typically made. First, independence between diseases is assumed. For example, a patient's risk for cardiovascular disease does not affect the calculated risk for cancer. The two models, though, may use the same risk factors such as age, sex, and race. A second assumption is that long-term health can be modeled using a Markov process. In other words, risk at time tₙ only depends on the health states at time tₙ₋₁, and it is independent of the patient's health at all previous time points.

To initialize the Markov process, the patient's current health is characterized by a set of health states. Typically, there is one “well” state, one or more “dead” states, and multiple “sick” states corresponding to the different disease combinations being modeled. For example, states labeled BrCa, CVD, and BrCa&CVD indicate that the patient has only breast cancer, only cardiovascular disease, or both breast cancer and cardiovascular diseases, respectively. Each state is given a probability value between 0 and 1, and the sum of the values for all states equals 1. The initial probabilities at time t=0 reflect the patient's current health, so that one state has a probability of 1, while the rest have probabilities of 0.

Decision trees are often utilized to combine simple disease risk prediction models. In particular, decision trees are commonly used to determine the state probabilities at time t=1, and then again for each iteration in the Markov process. The decision trees define the transition probabilities among disease states from one time point to the next. As a simulation of the Markov process progresses, sick and dead states become increasingly more likely. After a given number of iterations, or once the sum of the dead state probabilities is sufficiently close to 1, the simulation is ended. Multiple dead states can be used to determine the probabilities for specific causes of death.

FIG. 1 is an example of a representation of patient health state probabilities that is utilized in Markov process and decision tree analysis. As shown in FIG. 1, terminal nodes 110, 120, 130, 140, 150, 160 define health states. For this example, at the initial time t=0, the probability that the particular patient is in the “well” state 110 is 0.7, that the patient is in the “sick” state 120 is 0.3, and that the patient is in the “dead” state 130 is 0.0. At time t=1, the probability that the patient is in the “well” state 140 is 0.5, that the patient is in the “sick” state 150 is 0.4, and that the patient is in the “dead” state 160 is 0.1. Branches 170, 172, 174, 180, 182, 184, 190 represent the possible transitions between the health states.

In a decision tree analysis, combinations of diseases are each treated as distinct states. Initial distribution defines the node probabilities at time t=0. Simulations continue until the sum of the dead states is close to 1. For n diseases, there are 2ⁿ alive states and n dead states. The decision trees work by considering a single disease, or disease combination, at each node. The incidence and mortality of that disease defines the probability of the branches that lead to child nodes. For example, beginning in a well state, the first node might be Get_BrCa, with one branch representing a patient who develops breast cancer and another branch representing a patient who does not. The first branch leads to the node Has_BrCa_Get_CVD, which in turn has two branches indicating whether the patient develops cardiovascular disease in addition to breast cancer. The second branch from Get_BrCa leads to a Get_CVD node, which works in a similar manner. The leaves of the decision tree are the health states BrCa, BrCa&CVD, CVD, and well. Each health state has a similar decision tree whose leaves are all the possible states that can be reached in one iteration of the model.

There are many problems with using decision trees for modeling multiple comorbidities. In general, to fully model n diseases, 2ⁿ alive (well and sick) states and n dead states are required. Thus, as the number of diseases increases, both the number of decision trees and the size of the trees grow exponentially. All internal nodes and branch probabilities must be explicitly defined, which makes modeling extremely tedious and error prone when the number of diseases is greater than 4. The decision tree analysis is also inefficient, since the same equations are executed multiple times in different nodes of the trees, and, when a single toll (reward) function is used, simulations must be run separately for each disease. Standard Markov modeling software can therefore be tedious and error-prone to use when a number of independent diseases are being modeled. Among other problems, capturing all combinations of n disease states requires manually defining the 2ⁿ subtrees, tracking cumulative disease-specific incidence requires n iterations, and the order in which diseases are considered in the subtrees may introduce bias.

The most serious consequence of using decision trees is the inherent bias towards those diseases whose corresponding nodes are closest to the root of the trees. Adjustments can be made to compensate for this effect, but the adjustment calculations can be complicated, especially as the number of diseases increases. To illustrate this inherent bias in simple decision trees, consider a patient who has already developed both breast cancer (BrCa) and cardiovascular disease (CVD). Suppose the risk of death due to breast cancer alone during one iteration is 0.1, and the risk of death due to cardiovascular disease is 0.3. As shown in FIG. 2A, for the patient who initially has BrCa and CVD 205, modeling CVD 210 first, followed by modeling BrCa 215, leads to a probability of 0.3 that the patient dies 220 of CVD, a probability of (1−0.3)*0.1=0.07 that the patient dies 225 of BrCa, and a probability of 1−(1−0.3)*(1−0.1)=0.63 that the patient remains alive 230.

In contrast, as shown in FIG. 2B, modeling BrCa first 240, and then CVD 245, leads to a probability of 0.1 that the patient dies 250 of BrCa, a probability of (1−0.1)*0.3=0.27 that the patient dies 255 of CVD, and a probability of 1−(1−0.1)*(1−0.3)=0.63 that the patient remains alive 260. The order in which the two diseases appear in the decision tree therefore changes the risk of death from each disease by 3% for just one iteration. This bias may begin small, but it grows with each additional iterative cycle.

FIG. 3 is a graph of this bias for the two diseases of FIGS. 2A and 2B. As can be seen in FIG. 3, if the same tree is used for each iteration, which is almost always the case, then the bias continues to grow until, after 10 iterations, the order of the diseases changes the risks dramatically. In the example of FIG. 3, an initial 3% difference 310 in CVD mortality grows to an 8% difference 320 after the ten iterations. What has been needed, therefore, is an improved technique for modeling decisions involving multiple diseases and clinical outcomes.

### SUMMARY

The present invention is a method that models the impact of a treatment on a simulated cohort as a Markov process but avoids explicitly structuring a decision tree, defining toll functions, or entering bindings. Each possible combination of diseases is assigned a unique health state. Given a set of time-dependent risk functions and short and long-term mortality rates for each disease being modeled, a transition matrix is created that can be used to directly update the probability values of the health states by using a single matrix multiplication operation instead of a decision tree at each iteration in the simulation. The state probabilities are stored after each cycle, so that multiple life expectancy and quality adjusted life expectancy (QALE) estimates based on different utilities and discount rates can be calculated without having to repeat the entire simulation. In one aspect of the present invention, a web-based interface to the simulation allows users to perform sensitivity analysis and customize the model's clinical parameters and patient-specific risk factors.

In a preferred embodiment of the method of the present invention, various model-specific parameters, including parameters related to the diseases to be modeled, and patient-specific parameters, including physical characteristics, utilities, and preferences, are obtained and used in modeling the incidence and mortality rates for each specified disease. These disease-specific models are then used for Markov modeling of health states and associated probabilities, which in turn are used to formulate a transition matrix. The transition matrix is used in matrix calculation to obtain an output matrix, Q. If additional cycles are needed, the transition matrix is updated and matrix calculation is performed using the updated transition matrix. Otherwise, the final output matrix Q is utilized for calculation of various associated values needed to obtain the desired overall treatment score. The calculated values and/or values from Q are then combined to obtain a raw score that is then used to produce a final overall patient-specific score for a selected treatment.

In a preferred embodiment, the disease-specific mortality models employ two-part declining exponential approximation of life expectancy (DEALE) models. Complete directed graph representations are used in the Markov modeling step in order to accurately accommodate short-term mortality probabilities. Associated values obtained from output matrix Q and used in obtaining the overall treatment score include life expectancy (LE), quality-adjusted life expectancy (QALE), net benefit of treatment over control over any specified time period in terms of LE, QALE, and risk of specified disease endpoint or endpoints (cumulative disease-specific incidence or mortality). These values are combined to obtain a final patient-specific treatment score through a weighted sum of the individual values with values for other domains that affect treatment decisions and reflect the end-user's preferences for these various outcomes.

A software implementation of the present invention has been successfully used to simulate the impact of hormone therapy on the cumulative incidence of 8 chronic diseases and on QALE. By replacing complex trees with simple matrix multiplication, defining the model is far easier and less error-prone, bias due to the order in which diseases are considered is eliminated, and running the simulation is much faster than with other existing programs. By representing the simulation results in matrix notation, values such as life expectancy (LE), quality-adjusted life expectancy (QALE), and LE or QALE with a discount rate can be easily calculated and the method can be used to predict the outcomes of a treatment that has positive and negative effects on different long-term diseases.

### BRIEF DESCRIPTION OF THE DRAWINGS

FIG. 1 is an example of a representation of patient health state probabilities utilized in Markov process and decision tree analysis;

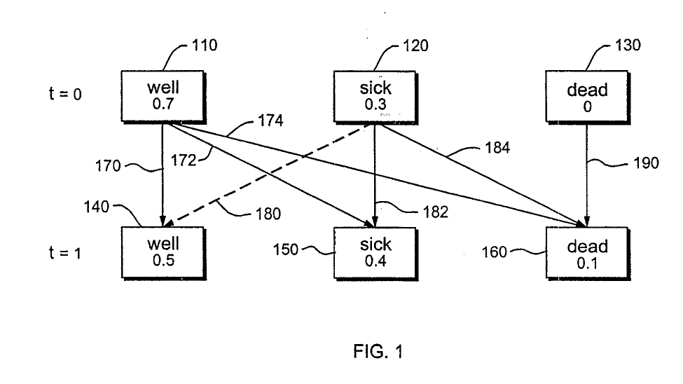

FIGS. 2A and 2B are example decision trees, showing the different results obtained depending on which one of two diseases is modeled first;

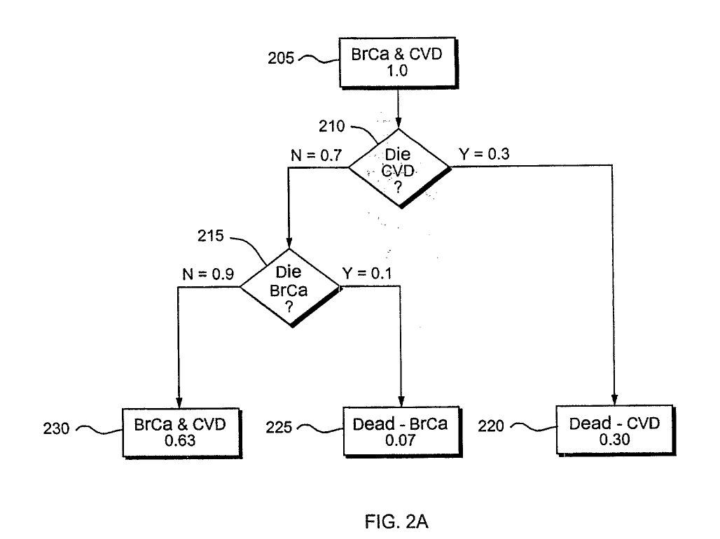

FIG. 3 is a graph of the bias introduced into the risk assessment for the diseases of FIGS. 2A and 2B, depending on which of the two diseases is modeled first in the decision trees;

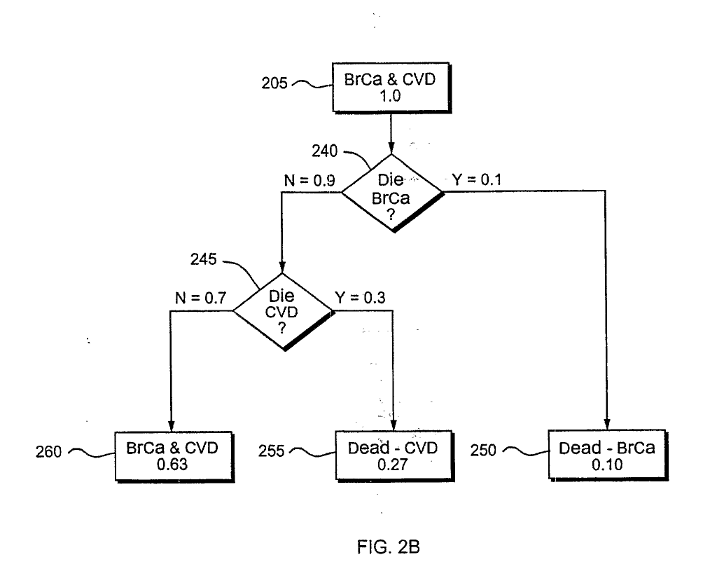

FIG. 4 is a block diagram depicting an analytical hierarchical model of risk assessment according to an embodiment of the present invention;

FIG. 5 is a block diagram depicting the integration of multiple domains according to an embodiment of the present invention;

FIG. 6 is a flow chart of an embodiment of the method of the present invention;

FIG. 7 is a graph depicting an example implementation of the model used in an embodiment of the present invention to represent the incidence and mortality rates of individual diseases, the declining exponential approximation of life expectancy (DEALE);

FIG. 8 is an example two-part DEALE model according to an aspect of the present invention;

FIG. 9 is an example two-part DEALE, partitioned to illustrate different causes of mortality, according to an aspect of the present invention;

FIG. 10 is an example of a Markov process modeled as a simple directed graph according to one aspect of the present invention;

FIG. 11 is an example of a two-part Markov process modeled as a directed graph according to one aspect of the present invention;

FIG. 12A depicts an example of matrix operations used in calculating the output of the simulation according to one aspect of the present invention;

FIG. 12B is an example output matrix according to an aspect of the present invention;

FIG. 13 is a screenshot of a screen allowing user entry of model-specific parameters according to one aspect of an embodiment of the present invention;

FIG. 14 is a screenshot of a screen that allows the user to enter patient-specific parameters according to one aspect of an embodiment of the present invention;

FIG. 15 is a graph of simulation results for the cumulative incidence of eight diseases, according to one aspect of the present invention;

FIG. 16 is a graph depicting the simulated cost of excluding combination states;

FIG. 17 is a screenshot from an example clinical trial utilizing the present invention to evaluate treatment options for menopause;

FIG. 18 is a graph of an example disease risk extrapolation according to an aspect of the present invention;

FIG. 19 is a screenshot from an example system implementing the present invention, depicting the interface whereby preferences for life expectancy (LE) and variables from other domains are defined in order to generate an overall treatment score;

FIG. 20 is another screenshot from the example system of FIG. 19, depicting the interface whereby the available treatment options may be managed:

FIG. 21 is another screenshot from the example system of FIG. 19, depicting the interface whereby the simulation parameters may be configured;

FIG. 22 is another screenshot from the example system of FIG. 19, depicting the interface whereby patient variables are entered;

FIG. 23 is another screenshot from the example system of FIG. 19, depicting the interface whereby the Markov simulation is run;

FIG. 24A is another screenshot from the example system of FIG. 19, depicting the interface whereby patient preferences are obtained;

FIG. 24B is the continuation of the screenshot of FIG. 24A; and

FIG. 25 is another screenshot from the example system of FIG. 19, depicting the interface whereby the final treatment scores are provided to the user.

### DETAILED DESCRIPTION

The present invention is an improved technique for modeling multiple comorbidities that eliminates the need for decision trees by replacing them with a single transition matrix, which can be used to directly update the state probabilities at each iteration in the simulation. By representing the simulation results in matrix notation, values such as life expectancy (LE), quality-adjusted life expectancy (QALE), and LE and QALE with a discount rate can be easily calculated. The present invention is preferably implemented as software that uses the method of the invention to predict the outcomes of a treatment that can have both positive and negative effects on different long-term diseases.

The present invention is a Markov process-based method that can be used to simulate the combined effects of a selected treatment option on multiple causes of morbidity or mortality. It models the impact of a treatment on a simulated cohort as a Markov process, but avoids explicitly structuring a decision tree, defining toll functions, or entering bindings. As with prior modeling methods, each possible combination of diseases is assigned a unique health state. Given a set of time-dependent risk functions and short and long-term mortality rates for each disease being modeled, the present invention creates a transition matrix, which can be used to update the values of the health states by using a single matrix multiplication operation instead of a decision tree. The simulation stores the state probabilities after each cycle, so that multiple QALE estimates based on different utilities and discount rates can be calculated without having to repeat the entire simulation. In a preferred embodiment, a web-based interface to the simulation allows users to perform sensitivity analysis and customize the model's clinical parameters and patient-specific risk factors.

The present invention has successfully been used to simulate the impact of menopausal hormone therapy on the cumulative incidence of 8 chronic diseases and on QALE. By replacing complex trees with simple matrix multiplication, defining the model is far easier and less error-prone, bias due to the order in which diseases are considered is eliminated, and running the simulation is much faster than with other existing methods. For example, a 25-year simulation with 5 diseases takes <1 second and with 8 diseases takes <10 seconds on a standard desktop computer. Simulation results are presented online as tables and graphs and can be exported as text files.

In order to model multiple comorbidities, several simplifying assumptions are made. First, independence between diseases is assumed. For example, a patient's risk for cardiovascular disease does not affect the calculated risk for cancer. The two models, though, may use the same risk factors such as age, sex, and race. A second assumption is that long-term health can be modeled using a Markov process. In other words, risk at time tₙ only depends on the health states at time tₙ₋₁ and it is independent of the patient's health at all previous time points. Another assumption that is made in the examples presented, but that is not a requirement for the present invention to work, is that once a patient develops a chronic disease, such as cardiovascular disease, he or she will never be “cured”—in other words, all future health states will indicate that the patient has the disease.

Recognizing that the effects of a treatment on LE and QALE are only some of the factors affecting decisions about initiating or continuing a treatment, it is desirable to integrate the impact of treatment on an individual's LE and QALE with any number of other domains that may influence treatment choice, including treatment side-effects (major or minor side-effects), convenience of dosing, route of dosing, costs, ethical concerns (i.e., concerns relating to the use of animals in research and manufacturing), health beliefs (natural vs. synthetic products), religious beliefs (e.g. blood products for Jehovah's witnesses), long-term consequences, and other relevant domains. All domains pertinent to that treatment decision are combined numerically to obtain a raw score that is used to produce a patient-specific score for a selected treatment option.

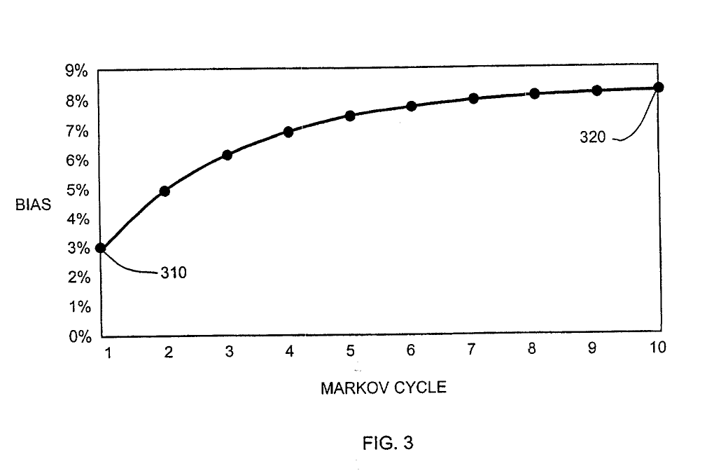

FIG. 4 is block diagram depicting an analytical hierarchical model of risk assessment according to an embodiment of the present invention. As shown in FIG. 4, in Level 1 of the model, a preferred treatment is selected 405. In Level 2, patient concerns related to the each treatment are incorporated, including survival concerns 410, quality of life concerns 415, cost concerns 420, and various other concerns 425. In Level 3, the clinical effects of each treatment are incorporated, such as life expectancy 430, chronic disease risks 435, major side effects 440, minor side effects 445, convenience 450, and drug costs 455. Finally, at Level 4 specific treatments 460, 465, 470 are outlined that impact the factors incorporated at the prior levels.

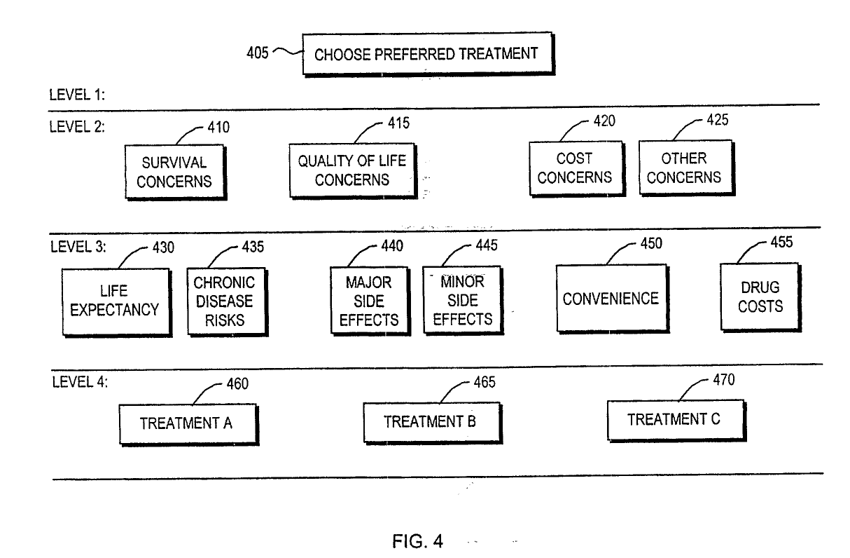

FIG. 5 is a block diagram depicting the example integration of multiple domains according to an embodiment of the present invention. The diseases present 505 are modeled through Markov processes 510 and the Markov modeling results are then used as inputs for the evaluation formula 515. In the example of FIG. 5, the diseases 505 for which the impact of a selected treatment is to be evaluated include breast cancer 520 and any other diseases present 525. The Markov model 510 is used to evaluate survival 530, as affected by quality of life adjustments 535, in order to obtain a quality-adjusted life expectancy 540. Values representing quality-adjusted life expectancy 540, major side effects 545, minor side effects 550, convenience 555, costs 560, and inputs from other domains 565 are then combined 570 with user preferences 575 by assignment of weights 580, producing a raw score 585 from which an overall treatment score 590 is derived.

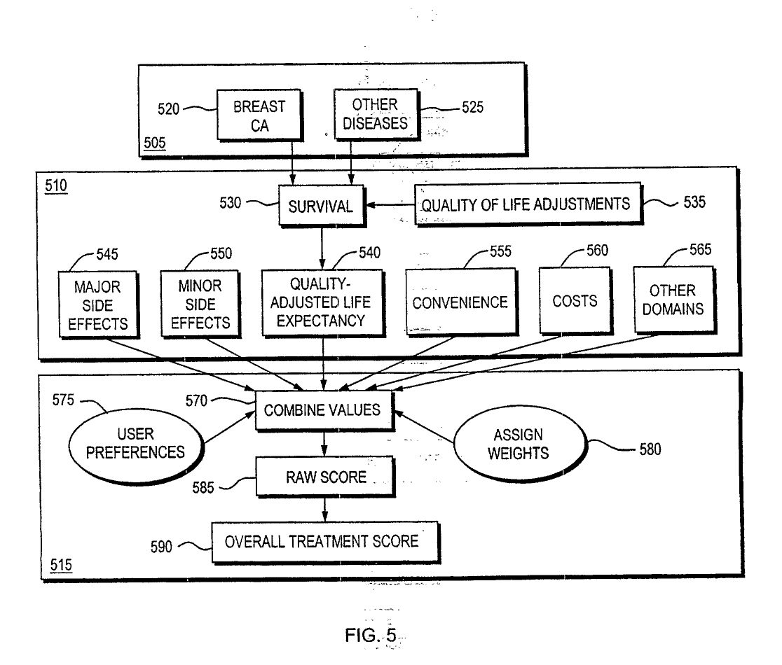

FIG. 6 is a flow chart of an embodiment of the method of the present invention. In FIG. 6, various model-specific parameters 610, including parameters related to the diseases to be modeled and the treatment or treatments to be considered, and patient-specific parameters 210, including physical characteristics and preferences, are obtained and used in modeling 630 the incidence and mortality rates for each specified disease. These disease-specific risk prediction models are then used to define health states and probabilities 640, which in turn are used to formulate 650 a transition matrix. The transition matrix is used in matrix calculation 655 to obtain an output matrix, Q. If additional cycles are needed 660, the transition matrix is updated 650 and matrix calculation 655 is performed using the updated transition matrix. Otherwise, the final output matrix Q is utilized for calculation 670 of various associated values needed to obtain the desired overall treatment score. The calculated values, values from other domains related to the treatment 675, and/or values from Q are then combined 680 to obtain a raw score that is then used to produce 690 a final overall patient-specific score for a selected treatment.

The model used in a preferred embodiment of the present invention to represent the mortality rates of individual diseases is the declining exponential approximation of life expectancy (DEALE). Although the method of the present invention can be extended to other types of models, the DEALE is a good predictor of the long-term survival of many diseases, and its mathematical properties greatly simplify the calculations performed in the simulation. The DEALE states that the fraction of a population surviving after t years is equal to exp (−μt), where μ is the hazard rate. The hazard rate is the inverse of life expectancy, but in practice it is usually found by looking at the fraction of a population (m) that survives for at least t years, and then calculating μ=−1n(m)/t.

In some cases, a single hazard rate is an oversimplification, because the short-term (e.g., less than one year) risk of death immediately after being diagnosed with a disease can be very different than the long-term risk. Typically, if patients survive the short-term period, then their annual mortality rates significantly decrease. To account for this, the present invention uses a two-part DEALE, in which a short-term hazard rate, μ_{S}, is used for the first simulation cycle, and a long-term hazard rate, μ_{L}, is used for subsequent iterations.

As previously discussed, when a patient is at risk of multiple comorbidities such as cardiovascular disease and breast cancer, simple decision trees fail to predict the combined effects. However, assuming disease independence, and using the DEALE to simplify the math, these calculations may be accurately made. Because of independence, the probability that a patient is alive after t years is the product of the individual survival curves,

exp(−μ₁t)*exp(−μ₂t)=exp[−(μ₁+μ₂)t].

Note that the product is also in the form of a DEALE. The equations can be extended for additional diseases so that the overall survival is exp(−μ_{C}t), where μ_{C}=combined hazard rate=μ₁+μ₂+ . . . +μₙ.The fraction of death due to a particular disease is therefore equal to the fraction of the combined hazard rate that can be attributed to that disease.

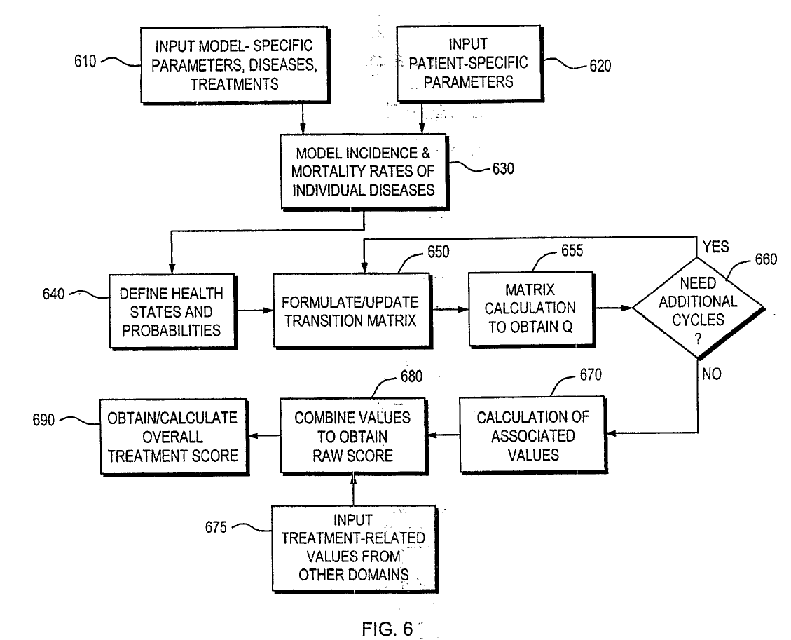

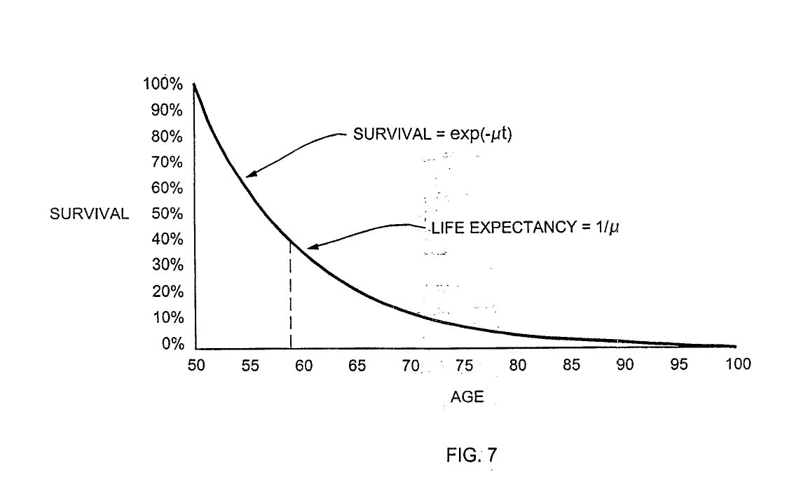

FIG. 7 is a graph of an example DEALE model as used in a preferred embodiment of the present invention. As shown in FIG. 7, survival=exp(−μt) and life expectancy=1/μ. If m % survive after t years, then μ=−1n(m)/t. FIG. 8 is a graph of an example two-part DEALE model as used in a preferred embodiment of the present invention. As can be seen in FIG. 8, the two-part DEALE recognizes that short-term risk 810, μ_{S}, is different than long-term risk 820, μ_{L}.

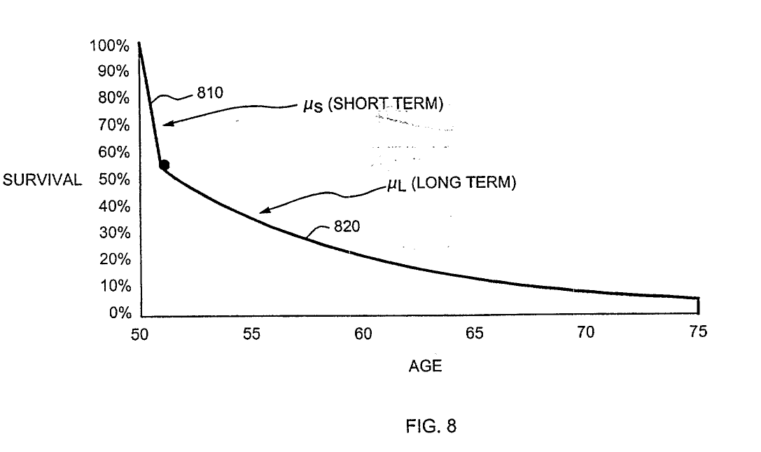

FIG. 9 is a graph of an example two-part DEALE model, partitioned to illustrate different causes of mortality. In other words, the relative values of the individual disease hazard rates indicate how the overall mortality should be partitioned into separate causes of death. The two-part DEALE is ideal for modeling comorbidities, treating diseases as independent causes of mortality. Combined mortality is still exponential. With the combined hazard rate=μ_{c}=μ₁+μ₂+ . . . +μₙ, the fraction of death due to each disease is equal to the relative values of their hazard ratios, which can be expressed as:

mortality due to disease x=(μₓ/μ_{C})*[1−exp(−μ_{C}t)].

As shown in FIG. 9, the patient's total probability of survival is a function of the probability of survival of CVD 910, BrCa 920, and other forms of mortality 930. For example, if the one-year mortality rate of CVD is 0.3 and the one-year mortality rate of BrCa is 0.1, it follows that μ_{CVD}=−1n(0.7)=0.357 and μ_{BrCa}=−1n(0.9)=0.105, and the combined hazard rate=μ_{c}=−1n(0.7)−1n(0.9)=0.462. The 1-yr CVD mortality is therefore calculated as (0.357/0.462)·[1−exp(−0.462)]=0.286. This value is between the extremes predicted by decision trees (0.27 and 0.30), but it is not simply the average.

While the preferred embodiment of the invention employs a two-part DEALE, any of the other techniques for modeling disease incidence and mortality may be advantageously employed in the present invention, including, but not limited to, using relevant raw data from epidemiological studies or survival analyses, in tabular form as direct table look-ups or by using such data to derive a fitted regression curve to represent disease-specific mortality over time, to assume that the combined probability of mortality from two or more disease equals the larger force of mortality of the multiple diseases, or to assume that the joint probability of developing two diseases concurrently is so small as to be assumed to equal 0.

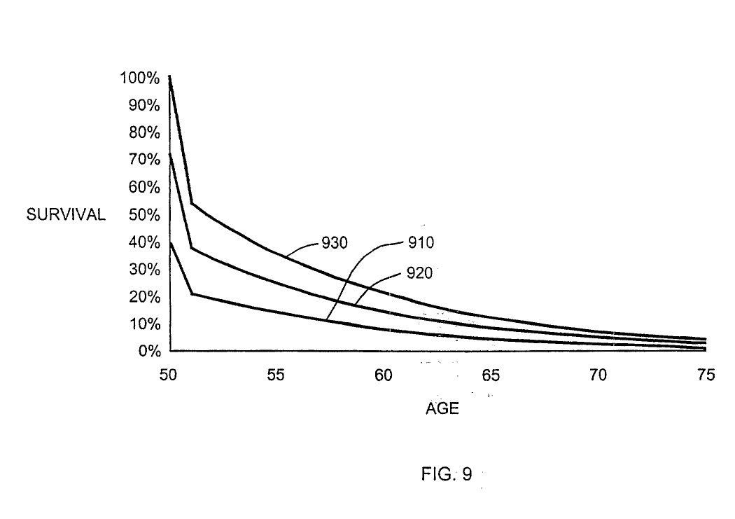

As an intermediate step towards building a complete model, the Markov process of the present invention may be represented as a simple directed graph, such as that shown in FIG. 10. In FIG. 10, circles 1005, 1010, 1015, 1020, 1025, 1030 represent health states, arrows 1035, 1040, 1045, 1050, 1055, 1060, 1065, 1070, 1075 represent transitions between states, and arrows 1080, 1082, 1084, 1086, 1088, 1090 represent remaining in the same state. Exactly one arrow from each state is followed during each cycle. Each arrow is associated with a probability value determined using the DEALE or other modeling method, and the sum of the probabilities of all arrows exiting a node is 1.

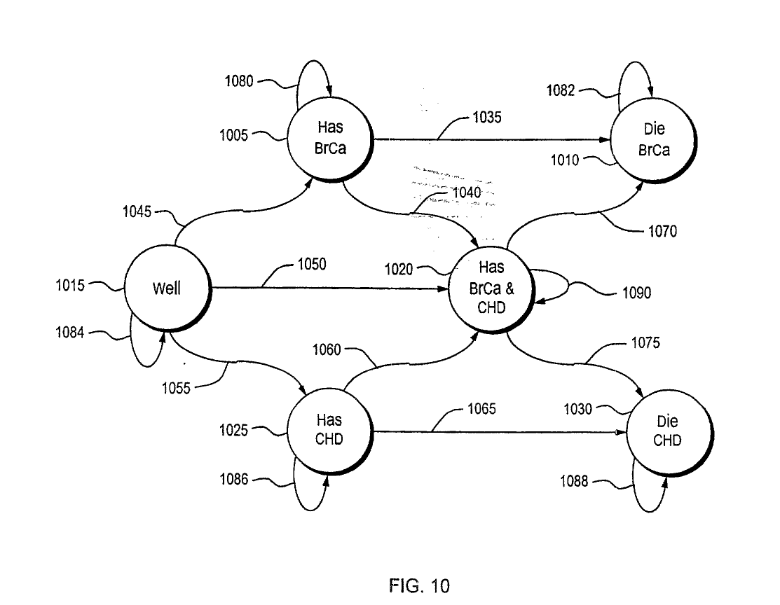

Some additional complexity may be introduced in order to model the two-part DEALE and short-term mortality. FIG. 11 depicts an example of a complete directed graph representation including short-term mortality. In the two-part model of FIG. 11, circles 1105, 1110, 1115, 1120, 1125, 1130 represent possible health states and diamonds 1140, 1142, 1144, 1146, 1148 represent branch points where short-term mortality (dotted lines 1150, 1152, 1154, 1156, 1158, 1160) “steals” some fraction of the people heading towards an alive state and redirects them to a dead state. Arrows 1162, 1164, 1166, 1168 1170, 1172, 1173 1174, 1175, 1176, 1177, 1178, 1179 represent transitions between states and arrows 1180, 1182, 1184, 1186, 1188, 1190 represent remaining in the same state. One cycle is a complete path from one circle to either the same or to another circle. Cumulative incidence totals are based on the fraction of people passing through diamonds 1140, 1142, 1144, 1146, 1148, not disease states. Again, the arrows each are assigned a probability value, and the sum of the probabilities of all arrows exiting a node is 1.

There is a subset of arrows in the simple graph that lead from an alive state to another alive state. Following one of these arrows is equivalent to acquiring one or more diseases within a single cycle (year) of the simulation. The two-part DEALE is used because some diseases have a high mortality rate within this first year. As a result, some fraction of the population heading towards the new alive state should actually be redirected to a dead state instead. Thus, the fall directed graph divides each alive-to-alive transition in the simple graph into two or more branches: one for the original alive-to-alive transition, with additional branches leading to death states for each of the newly acquired diseases. Transitions from existing diseases to death states already exist in the simple model.

From the directed graphs, the matrix representation of the model can now be formulated. For n diseases, the model contains 2ⁿ alive states and n dead states (2ⁿ+n total states). Letting vector πᵢ(t) be the probability (or the fraction of a cohort) of state i at time t, and Pᵢⱼ(t) be the transition probability from state i to state j at time t, the states in π(t) will be ordered such that the index of an alive state, written in binary form, corresponds to the diseases that are present. The well state has index 0, and the dead states will have the highest indices. The states for the example using CVD and BrCa, are presented in Table 2.

TABLE 2

| State | Name | Description |
|---|---|---|
| 0 | alive₀₀ | Well |
| 1 | alive₀₁ | CVD |
| 2 | alive₁₀ | BrCa |
| 3 | alive₁₁ | CVD&BrCa |
| 4 | dead₀ | Dead_CVD |
| 5 | dead₁ | Dead_BrCa |

By ordering the states in this manner, the transition matrix P(t) can be divided into 4 partitions, as shown in Table 3:

TABLE 3

| Partition I | Partition II |
|---|---|
| alive → alive | alive → dead |
| (upper triangular) | |
| Partition III | Partition IV |
| dead → alive | dead → dead |
| (zero matrix) | (identity matrix) |

The upper-left quadrant of Table 2 contains transitions from alive states to alive states. Because of the assumption that long-term diseases are permanent, this partition is upper-triangular. The upper-right quadrant contains alive to dead transitions, which includes both short-term and long-term mortality. The lower-left quadrant contains dead to alive transitions, and consequently, this partition is a zero matrix. Finally, the lower-right quadrant is an identity matrix with dead to dead transitions. The initial probability distribution is given as π(0), and each Markov cycle updates the state probabilities using:

π(t)*P(t)=π(t+1)

In one embodiment of the present invention, the transition matrix P(t) is constructed using three sets of “model-specific” equations. pGetᵢ(t,X) is the incidence of disease i at cycle t given “patient-specific” variables X=(x₁, x₂, . . . , Xₘ). The patient-specific variables include risk factors such as age, sex, race, weight, smoking habits, and exercise level. pDieSᵢ(t,X) is the short-term mortality rate of disease i, and pDieLᵢ(t,X) is the long-term mortality rate of disease i. Thus, for n diseases only 3n equations must be given to define the entire model. This is an enormous improvement over decision trees, which scale exponentially with respect to the number of diseases.

The output of the simulation is a single matrix Q, which combines the state probability vectors from each cycle. Each row in Q corresponds to a different health state, and each column corresponds to a different cycle. The first column of Q is therefore π(0), and the last column is the final state probabilities at time tₘₐₓ. Thus, Q has dimensions 2ⁿ+n, where n is the number of diseases, by tₘₐₓ, the last cycle run. No toll functions, discount rates, or quality of life adjustments have been introduced into the model up to this stage. The output matrix Q is independent of these things. Q can then be used to generate different types of results.

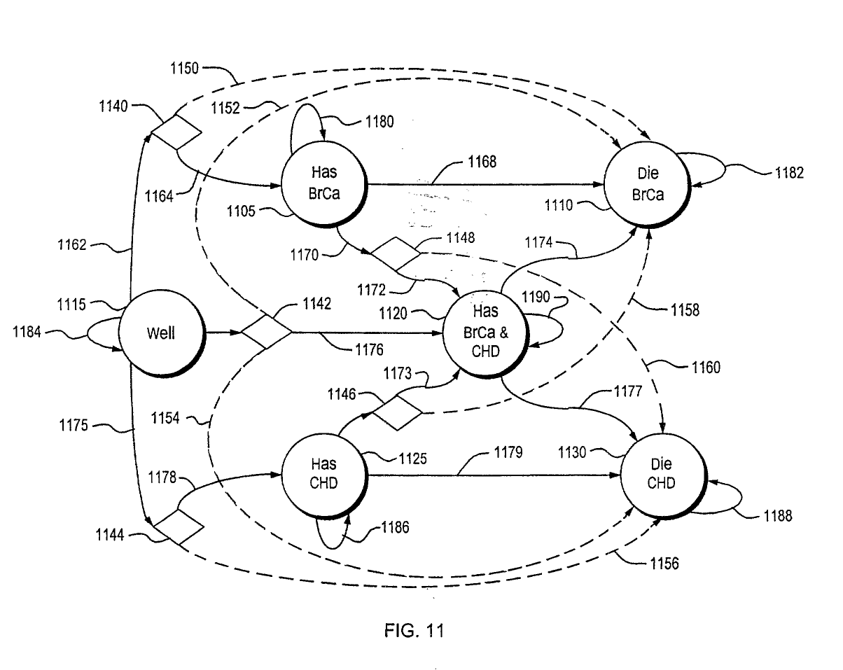

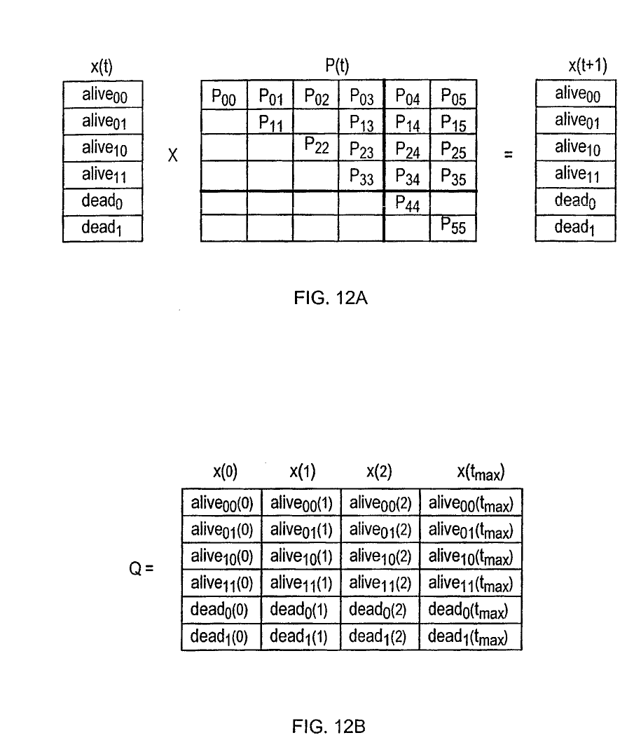

FIG. 12A depicts an example of matrix operations used in calculating Q. The initial probability distribution is given as x(0). For each Markov cycle, x(t)·P(t)=x(t+1). The transpose of π is shown in FIG. 12A. The simulation can continue for a fixed number of cycles to determine the probability of different health state when a patient reaches a certain age, or it can be run until the sum of the probabilities of the dead states are sufficiently close to 1. The partitioned structure of the transition matrix P(t) and the particular properties of each quadrant allows for an efficient matrix multiplication implementation.

FIG. 12B depicts the simulation output, the single matrix, Q, combining the state probability vectors (one state per row) at each cycle (one cycle per column). Simulation run time is minimized by calculating toll functions, incorporating discount rates, and adjusting for quality-of-life after matrix Q is constructed. Partition I probabilities indicate disease incidence with some fraction removed for short-term mortality. Partition II probabilities are the sums of short-term and long-term mortality.

From the single matrix Q, a number of quantities can be calculated without repeating the simulation. For example, let W be a vector of length 2ⁿ+n that assigns a weight (e.g., quality-of-life estimate) between 0 and 1 to each state, and let V be a vector of length tₘₐₓ that assigns a weight (e.g., a discount rate) to each cycle. To estimate life expectancy, set the first 2ⁿ values in W to 1, and the rest 0. Set all the values of V to 1. Life expectancy (LE) is then simply:

LE=(W*Q*V^{T})/tₘₐₓ.

A quality adjusted life expectancy (QALE) can be calculated by decreasing the values in W that correspond to sick states, then plugging into the same equation used to estimate LE. A QALE with a discount rate r can be computed by setting V(i)=1−rⁱ, and then once again using the same equation as LE, but with new W and V vectors.

The effects of changing the values in W and V can be repeatedly tested using the same matrix Q, without having to repeat the whole simulation. The one equation described here is significantly faster to compute than forming Q. Sensitivity analysis on quality-of-life and discount rates are therefore particularly efficient with this method.

This method can also be used to determine the net benefit of a treatment T over a control C. The simulation is run twice: once with model-specific equations that reflect the control, and a second time using modified equations that reflect the positive or negative effect of the treatment on each disease. The result is two Q matrices, Q_{C} and Q_{T}. The net benefit is therefore:

(QALE)_{T}−(QALE)_{C}=(W*Q_{T}*V^{T})/tₘₐₓ−(W*Q_{C}*V^{T})/tₘₐₓ

If this equation evaluates to greater than zero, then the treatment has a net positive benefit.

Life Expectancy (LE) can be calculated for the states listed in Table 2 as follows: Let W be a vector of length s that assigns a weight (e.g., quality-of-life estimate) between 0 and 1 to each state and let V be a vector of length tₘₐₓ that assigns a weight (e.g., a discount rate) to each cycle, then:

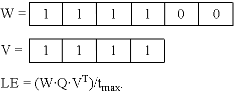

Again, using the states in Table 2, Quality-of-Life Adjusted Life Expectancy may be calculated by:

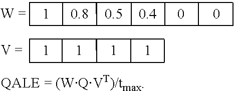

QALE with Discount Rate r is:

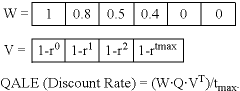

Net Benefit of Treatment (T) over Control (C) may then be calculated as:

(QALE)_{T}−(QALE)_{C}=(W·Q_{T}·V^{T})/tₘₐₓ−(W·Q_{C}·V^{T})/tₘₐₓ.

While calculation of the specific parameters described above is utilized in the preferred embodiment of the present invention, many other parameters and values may be advantageously employed for obtaining scores for specific treatments and/or diseases, including, but not limited to the relative probabilities of different health states, the cumulative probability of a single health state, and the duration of time where the probability of a health state remains below a threshold level. In addition, scores for treatment options can come from sources other than the Markov simulation. These scores may include, but are not limited to, treatment side-effects (major or minor side-effects), convenience of dosing, route of dosing, costs, ethical concerns (i.e., concerns relating to the use of animals in research and manufacturing), health beliefs (preference for plant based vs synthetic products), religious beliefs (e.g. blood products for Jehovah's witnesses), long-term consequences, and other relevant domains.

Several methods are suitable for combining individual treatment scores into a single overall score that reflects end-user preferences for multiple domains. The preferred method is one that integrates all domains into a single unifying metric that can then be scored, drawing on core aspects of multi-criterion decision analysis (also referred to as analytic hierarchical processes, or AHP) to embed patient preferences. All domains are unified using an approach that compares increments of gains (or losses) in one domain to incremental gains or losses in another, using a common preference scale. In a series of pair-wise comparisons, each domain is compared to every other domain. If many domains are needed, simple hierarchies are used to reduce the number of comparisons. The specific domains used, increments of gain or loss in each domain, and framing of the preference-elicitation questions can be determined based on input from end-users or an expert or expert panel.

The framing of information on risks and treatment options draws upon the Health Belief Model and social cognitive theory, theories which address factors relating to risk perception, susceptibility to health threats, and severity, and reciprocal interactions among behavior, personal factors, and environmental influences. Preference-elicitation schema, based on a series of pair-wise comparisons, are preferable because they are consistent with Prospect theory, which describes how people manage risk and uncertainty.

The AHP method combines individual scores characterizing a treatment option into a single raw score, which is specific to a particular patient. The raw score can be transformed into a rating scale that can be translated into discrete grades, “A” (highly appropriate) through “F” (highly inappropriate).

There are other techniques for combining multiple scores describing a treatment option into a single raw score. For example, linear methods assign weights to the various scores or domains, and then a weighted sum forms the raw score. A more complex function for calculating a raw score could include nonlinear combinations of the scores. Examples of nonlinear models include, but are not limited to, decision trees, artificial neural networks, and logistic regression models.

In order to use many of these techniques, model parameters must be determined. Model parameters can be the weights in a linear model, constants in more complex functions, or the choice of which function is used. There are different ways of assigning values to these model parameters. A simple method is to assign equal or random values to the model parameters. Another approach is to have weights directly assigned (by an expert panel and/or consumers) to reflect the relative value that each has (ex: JNCI approach for net benefit-risk of tamoxifen, Gail model).

The model parameters can be based on user preferences. One method for assigning weights is the Trade-off method for comparing domains: This can be done by first dividing each domain into 10 mutually exclusive even categories. For example, for life expectancy, categories can be defined as no significant impact on survival, >1 month gain, >3 months gain, >5 months gain, >7 months gain, >9 month gain, >11 month gain, >13 month gain, >1 month loss (note that these categories can be defined according to the treatment category). Pairwise comparisons between each domain category, based upon expert panel and consumer input, can be used to generate the specific weights. The starting point for such comparisons would be asking people how much they would be willing to pay (or trade-off) in each other domain to gain 1 month in life expectancy (ie, monthly drug cost, amount of side effects, etc). This amounts to asking for the point of indifference across specific intervals across categories.

The analytic hierarchy process (AHP) can also transform user preferences into weights. AHP is a decision support technique developed in the 1970s that has been successfully applied in medical decision making (Saaty1994; Castro 1996; Dolan 1993). This approach involves setting up a multi-level hierarchy of influence. The goal of the model is located on the top (level 1). The major concerns that influence the choice of treatment are located directly below the goal (level 2). These may include survival, quality-adjusted survival, costs, major and minor side effects, health beliefs, religious beliefs, ethical concerns, and convenience. The next level contains details related to level 2. The treatments from which the choice ultimately will be made are located in the next level. Pairwise comparisons related to medical questions can be solicited from an expert panel or an individual decision maker, who rate elements on a scale of 1-9 according to their views of the importance of the criteria with respect to an element in the level immediately above. There is standard software that performs these analyses (Expert Choice 8.0). Note that in this approach, the various domains are unscaled.

A further suitable method for determining model parameters is to use one of many available artificial intelligence (A.I.) techniques for automatically learning the best values. A.I. techniques can also be used to define the entire structure of the formula. To begin, an expert panel is presented with a set of hypothetical cases. Each case contains different values for the individual scores of one treatment option, and the expert panel may vote on whether it would recommend that treatment option to a patient. An artificial intelligence model (such as logistic regression, decision trees, or artificial neural networks) can be “trained” using the votes of the expert panel. The model generated by the A.I. algorithm can then later be used to predict the vote of the expert panel on a new case. This prediction can be binary (yes or no), or it can be an estimated probability that the treatment should be recommended to the patient.

The artificial intelligence model can be augmented by individual patient preferences. This can be done either by allowing patients to modify the parameters in the model (directly, by controlling their values, or indirectly, though an alternative means), or by explicitly using patient preferences as a separate parameter in the model. For example, one variable in a logistic regression model could be the relative weight a patient places on the importance of treatment cost. The various individual scores and user preferences are the “input parameters” of the A.I. model. The output is the prediction of how the expert panel would vote. The techniques for constructing and training different types of A.I. models are well known in computer science and statistics.

While weighted sums selected using AHP, as described above, are utilized in the preferred embodiment of the present invention, any of the many other techniques listed above or known in the art may be advantageously employed for combining the various parameters and scores. For certain individual treatment scores, there are known methods for combining them. For example, years of life expectancy can and treatment cost can be mapped easily to the same scale. Other domains, such as convenience of dosing, might first have to be converted to a numeric scale before they can be combined with domains such as life expectancy. Defining this transformation might require an expert panel.

Combining the individual scores for a treatment option produces a raw score, which is used to generate the final output of the program. The output itself can be a number (e.g., an “overall score”), but this number does not have to be equal to the raw score. For example, the raw score might take any real number values, while the overall score is a number between 0 and 100, or a grade between F and A+.

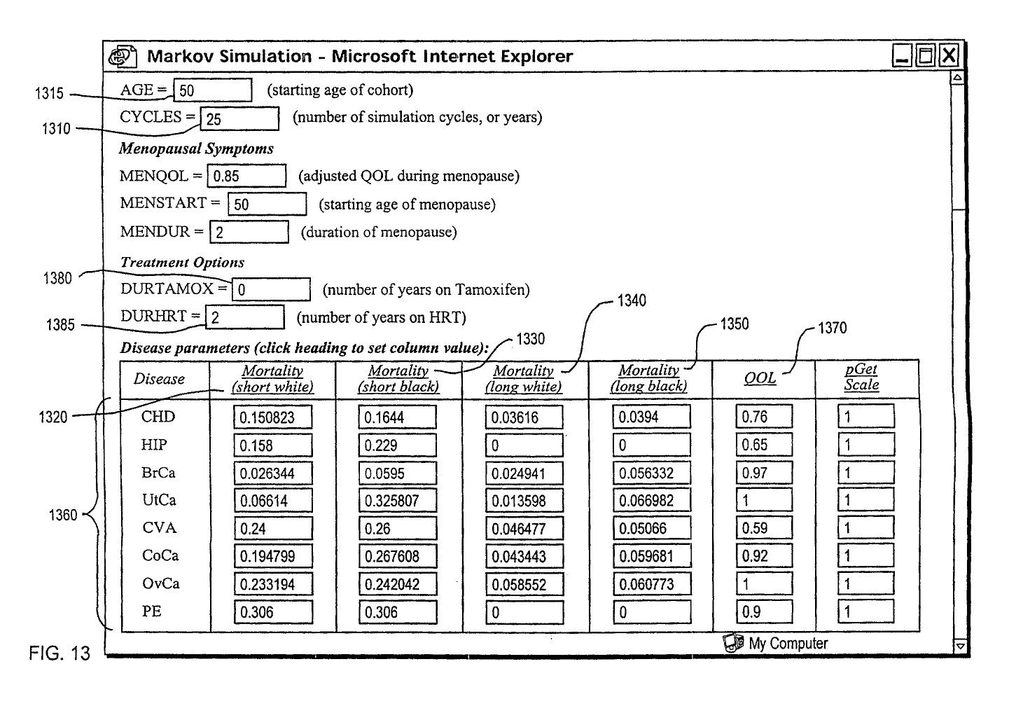

A web-based interface has been developed to implement the data input functions for an embodiment of the present invention. The software presents two data input screens. The first screen allows the user to modify model-specific parameters. FIG. 13 is a screenshot of an example screen permitting user entry of several model-specific parameters. These are the variables that control the operation of the program, such as the number of Markov cycles to simulate 1310 and the cohort starting age 1315, variables that are derived from the scientific literature, such as the population-wide mortality rates 1320, 1330, 1340, 1350 of different diseases 1360 and quality of life estimates 1370, and treatment options 1380, 1385.

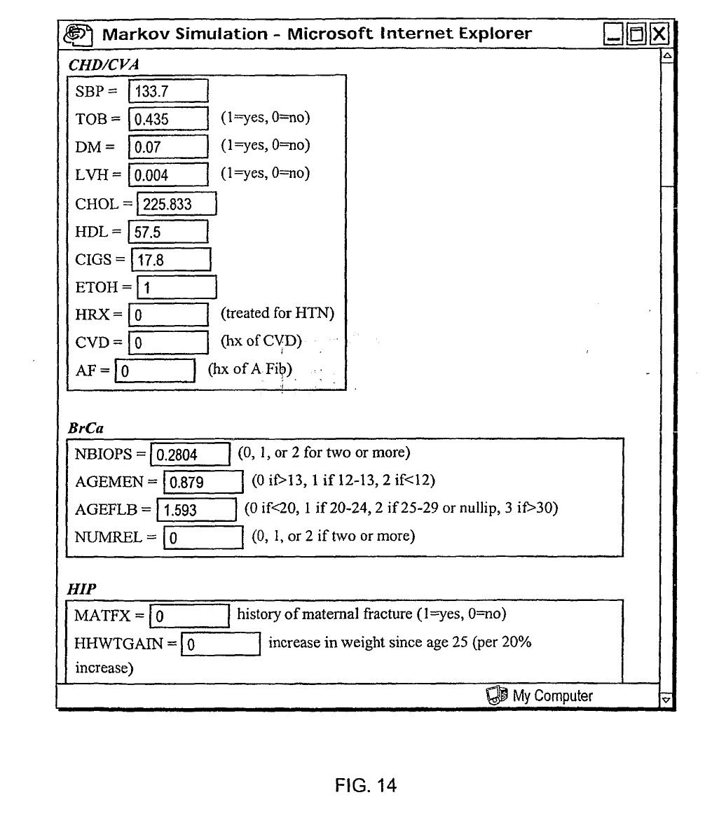

The second screen permits the user to enter patient-specific parameters, which are the variables that reflect the particular characteristics of a specific patient such as height, weight, cholesterol level, and blood pressure. FIG. 14 is a screenshot of an example screen that permits the user to enter patient-specific parameters.

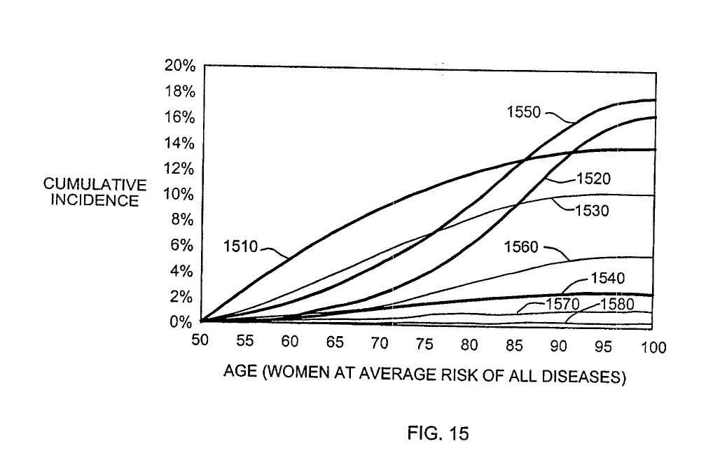

After user input is complete, the software then runs the Markov simulation and generates a graph of the predicted cumulative incidence of each disease. A large number of diseases can be simultaneously modeled without excluding any combination states (states containing multiple diseases). For example, FIG. 15 is a graph of simulation results for the cumulative incidence of 8 diseases utilizing the present invention. In FIG. 15, cumulative results are shown for coronary heart disease (CHD) 1510, HIP 1520, breast cancer (BrCa) 1530, uterine cancer (UtCa)1540, CVA 1550, colon cancer (CoCa) 1560, ovarian cancer (OvCa) 1570, and PE 1580.

The output of the simulation can provide calculations of life expectancy, quality adjusted life expectancy, and the fraction of mortality attributable to each disease. The software may also optionally provide an interface for performing sensitivity analysis. In the current implementation, up to three parameters can be selected. For each parameter, an increment amount and minimum and maximum values are chosen. The software then runs the Markov simulation for all combinations of the three parameters and displays tables showing the corresponding life expectancies and quality adjusted life expectancies. The sensitivity analysis can be used for a variety of applications, including determining the types of patients who will benefit or be harmed by a particular treatment option.

One of the main advantages of the present invention is the ability to model fully many diseases simultaneously. An approximation that other models make is to assume that the probability of a patient having many diseases at the same time is very low, and that ignoring these states will only have a small effect on the outcome. It is possible to evaluate whether this assumption is valid by running the Markov simulation twice—once using all of the states, and once calculating cumulative incidence without including any of the combination (multiple disease) states. A 50-year simulation of women at high risk for both CHD and BrCa shows that the combination states account for 8% of the cumulative disease incidence.

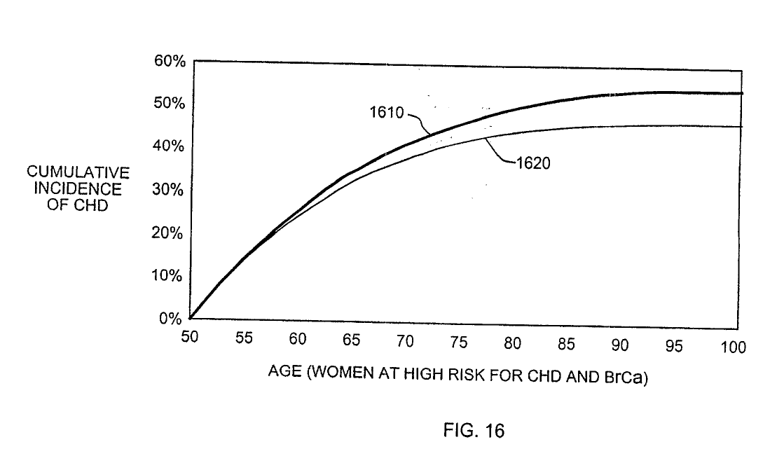

FIG. 16 is a graph depicting the simulated cost of excluding combination states for the CHD example. Large errors can result from “pruning” a decision tree by excluding combination states. This significant result illustrates the importance of using all combination states in the model. As seen FIG. 16, the estimated risk of CHD when combination states are not excluded 1610 is approximately 8% higher than the estimated risk when combination states are excluded 1620.

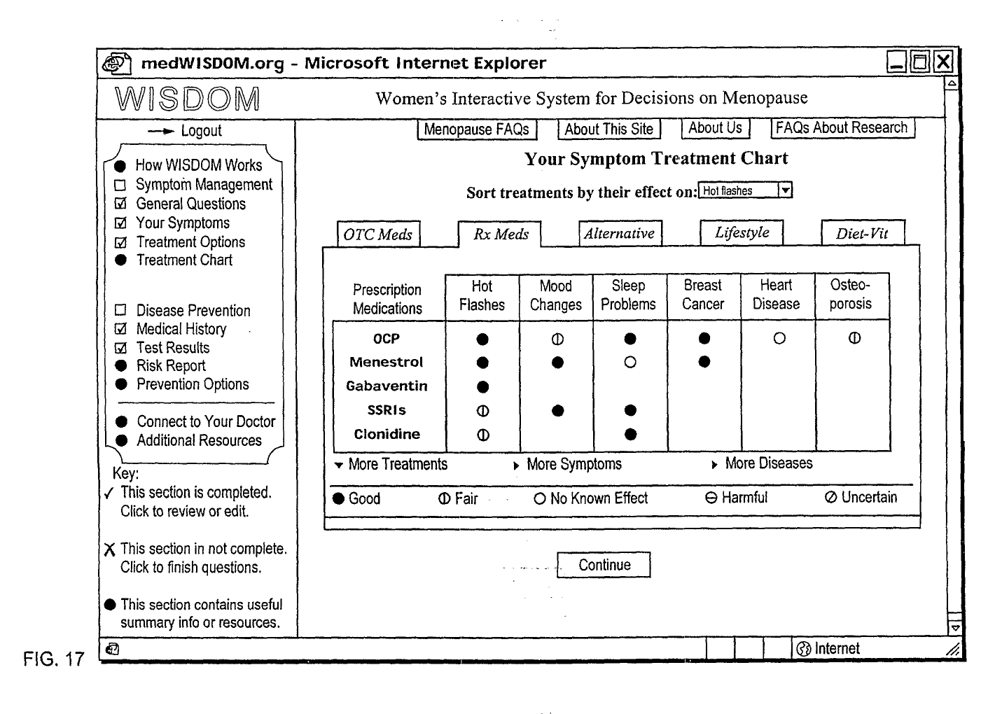

FIG. 17 is a screenshot from a clinical trial utilizing the present invention to evaluate treatment options for menopause. In this trial, letting CHOL=250, HDL=35, TOB=1, and DM=1; then no HT→QALE_{C}=69.1, while 2-yr HT→QALE_{T}=68.9. Therefore, HT reduces life expectancy for this patient. However, if V=(1, 1, 0, 0, . . . , 0), 0=W·Q_{C}·V−c·W−Q_{T}·V>c=1.087 then, if HT yields an 8.7% improvement in quality-of-life during 2 years of menopause, the net change in QALE is zero.

If desired, the present invention may be used in conjunction with any of the many extrapolation techniques known in the art. Simulations that estimate life expectancy often must extrapolate risk models well beyond their valid intervals. Being able to model life expectancy (LE) or quality-of-life adjusted life expectancy (QALE) accurately is essential to predicting the long-term effects of a treatment option. Preventive therapies can produce small gains in LE. For example, quitting cigarette smoking adds 8 months LE to a 35-year-old woman at average risk of cardiovascular disease. A 35-year-old women at high risk for CVD and more than 30% over ideal weight gains 13 months LE by a reduction in weight to ideal level (Wright JC, Weinstein MC. Gains in life expectancy from medical interventions—standarizing data on outcomes. N Engl J Med. Aug. 6, 1998; 339(6):380-6).

Extrapolation beyond the valid interval is necessary in part because Markov processes used to estimate life expectancy often require 50 or more simulated years (cycles). Most disease-specific risk models predict over intervals of only 5-10 years. For example, CVD risk models are valid from 4 through 12 years. Therefore, LE estimates usually require extrapolation of risk models well beyond their valid intervals. It is difficult to perform a 50-year clinical trial to determine the long-term risk of a disease.

In one simulation, the coronary heart disease (CHD) risk appraisal model (a Weibull equation) from the Framingham Study (2000) was applied to a hypothetical cohort of typical 50 year-old women to estimate the 1-year incremental CHD risk after age 50. The Weibull equation predicts cumulative risk from 1 to 4 years. By subtracting two sequential cumulative risk values, the 1-year risk is approximated. The CHD risk equation, P(n,t) takes two parameters: age (n) and duration (t). Four methods for estimating long-term CHD risk have been explored, calculating 1 year risk at age n using: Method A) P(n,1), incrementally augmenting age by1; Method B) P(n,2)−P(n,1); Method C) P(50,n−50+1)−P(50,n−50); and Method D) initially calculating P(50,1), then for age 50+m for m=1, 2, 3, calculating P(50,m+1)−P(50,m); then for age 54 start again with P(54,1), incrementing the starting age every 4 years.

The short-term and long-term CHD models predict incidence rates up to 4 and 12 years, respectively. These can be extrapolated as follows: Let P(n,t) be the cumulative incidence rate of CHD, for women age n over a duration of t years. P(n,t) can be based on either the short-term or long-term models. There are multiple ways of using P(n,t) to calculate the annual incremental incidence rate, r, depending on whether we want to change n, change t, or change both parameters. For example:

Extrapolation Method A: Let x=P(n,max{1,tmin}) where tmin is the minimum valid duration (t). Annual incidence rate=r=1−[1−x](1/max{1,tmin}). If tmin<=1, then the annual incidence rate=P(n,1). Increment age (n) by one for each Markov cycle. Duration remains constant.

Extrapolation Method B: r=P(n,max{1,tmin}+1)−P(n,max{1,tmin}). If tmin<=1, then r=P(n,2)−P(n,1). Increment age by one for each Markov cycle. Duration remains constant.

Extrapolation Method C: Let n0 be the initial age of the simulated cohort. r=P(n0,[n−n0]+1)−P(n0,[n−n0]). Age remains constant. Duration increases by 1 each cycle. Within the valid duration interval, this is the most accurate method of determining the annual incidence rate.

Extrapolation Method D: Let tmax be the largest valid duration. Let T=tmax−tmin. Let m=n−[(n−n0)mod T]. Let s=tmin+(n−m). r=P(m,s+1)−P(m,s). Age increments by T once every T years. Duration increases by 1 each cycle, but is “reset” every T years. This “sawtooth” method alternates between incrementing age and duration to stay within the valid duration interval while changing age as infrequently as possible.

Table 4 shows the calculations for annual incidence rate when performing a 6 year Markov simulation of a cohort whose initial age is 50, using the short-term CHD model.

TABLE 4

| | Method | | | |
|---|---|---|---|---|
| Age | A | Method B | Method C | Method D |
| 50 | P(50, 1) | P(50, 2)-P(50, 1) | P(50, 1) | P(50, 1) |
| 51 | P(51, 1) | P(51, 2)-P(51, 1) | P(50, 2)-P(50, 1) | P(50, 2)-P(50, 1) |
| 52 | P(52, 1) | P(52, 2)-P(52, 1) | P(50, 3)-P(50, 2) | P(50, 3)-P(50, 2) |
| 53 | P(53, 1) | P(53, 2)-P(53, 1) | P(50, 4)-P(50, 3) | P(50, 4)-P(50, 3) |
| 54 | P(54, 1) | P(54, 2)-P(54, 1) | P(50, 5)-P(50, 4) | P(54, 1) |
| 55 | P(55, 1) | P(55, 2)-P(55, 1) | P(50, 6)-P(50, 5) | P(54, 2)-P(54, 1) |

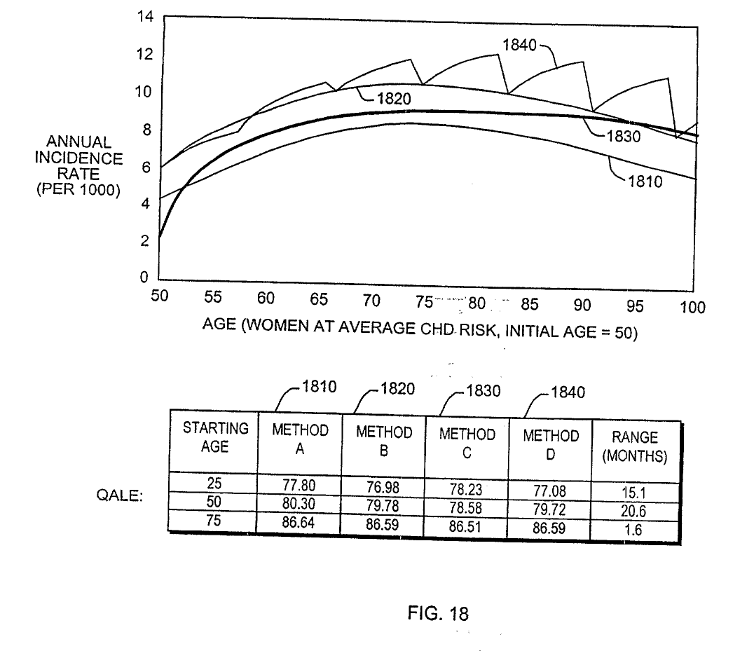

FIG. 18 is a graph of disease risk extrapolation according to an aspect of the present invention, depicting the effect of extrapolation on CHD incidence rates. As can be seen, the choice of extrapolation method has a large effect on the estimated annual incremental incidence rate of CHD. The graphs in FIG. 18 illustrate the results using method A 1810, method B 1820, method C 1830, and method D 1840, as applied to the short-term and long-term CHD models with initial cohort ages of 25, 50, and 75. In the short-term model equations, the positive coefficient for [Age×Menopause] produces a negative slope in the incidence rate curves for some of the extrapolation methods beginning at age 50 years.

The extrapolation method chosen has a marked impact on the predicted cumulative or incremental risk of CHD. Method A does not extrapolate beyond the four-year limit, but assumes that the patient's risk factors will be the same at all ages. Method B gives a higher estimate by taking the difference between years' 2 and 1 estimates. Method C extrapolates beyond the valid interval, yielding the highest estimates. Model D applies the Weibull equation most closely to how it was intended for the first 4 years, then increments the age by four years and starts again. However, although this model may be most accurate, it results in a discontinuous function.

The present invention is preferably implemented as a software application. The presently preferred embodiment is implemented as two separate programs. The front-end is a web site built with Active Server Pages (ASP), which includes HTML, JavaScript, and VBScript code. It passes the values of user-specific variables to a separate back-end server-side application, written in Perl, which runs a Markov decision model and returns risk and LE estimates. Both programs run on Microsoft Windows 2000 Server with Internet Information Services (IIS) 5.0. Support for executing Perl scripts is provided by ActiveState ActivePerl software for Microsoft Windows. The ASP front-end uses AspExec from ServerObjects.com to call the back-end Perl script. The website employs an SQL Server database. Many other languages, applications, platforms, and operating systems known in the art may also be advantageously employed to implement the present invention, including, but not limited to the Java, C, C++, and Microsoft .Net programming languages, the Unix, Linux, MacOS, and other Microsoft operating systems, and the Microsoft Access database application. The software can be implemented as a web site, a web service, a stand-alone application, or a component of another application. It can be accessed via computers, hand-held devices, cellular phones, and other electronic devices.

In an example system that employs an embodiment of the methodology of the present invention, patients interacting with a website are asked questions on-line about their risk factors for breast cancer, their risks for other disease, and their preferences. The system then integrates this information, links it with a database of available preventive options, and generates tailored feedback for the patient and her PCP. This feedback may include a list of available risk-reducing options for each individual, each graded according to its expected net benefit, accounting for their risks and preferences. Users can explore their risk for breast cancer, strategies for risk reduction, and options for early detection.

None of the riskier prevention options (such as Tamoxifen for chemoprevention) receive high grades for users at lower risk for breast cancer or for users whose risks for side-effects is greater than the reduction in risk from breast cancer. For such users, lifestyle changes (smaller efficacy, but lower risks) and mammography screening will be emphasized. On the other hand, higher-risk users could receive high grades for the riskier chemopreventive or surgical strategies (depending on their risks for side-effects and preferences), which would then draw them into an exploration of their personal risks. The grades can be deconstructed into their various component parts, including impact on survival, breast cancer risk, and other domains identified during focus groups. Information is presented simply at first, with an option to drill down to more detail. This allows users to customize the level and depth of information to their own personal needs, making the system useful for patients of many literacy levels. The first layer of information contains simple grades, the second delves deeper by deconstructing treatment grades into their various component parts (giving grades for each part).

Generation of treatment scores in this example system builds upon several innovative modeling methods and software technologies that have been previously developed and tested, including the present invention. These technologies are integrated through the specific mathematical formula of the present invention in order to generate a preference-weighted patient-specific treatment score. Personal risk factors are linked to the expected impact of treatments on life expectancy (LE) and quality-adjusted life expectancy (QALE) is used. The software utilizes a decision analytic Markov model that has embedded regression equations that link patient risk factors to future disease risks (for breast cancer, stroke, CHD, osteoporosis, endometrial cancer, VTE), accounting for competing mortality.

Quality adjustment of life expectancy (QALE) considers not only length of life, but also the QOL of the extended period. QOL estimates for this example system are derived from published utility scores for the serious conditions potentially affected by breast cancer prevention strategies through a literature search, using utilities for affected persons. Recognizing that decisions about treatment are affected by many factors beyond efficacy and survival, the methodology underlying this system includes any number of other domains that influence treatment choice, including side effects, convenience, costs, and other domains identified during the development phase. Each domain, its label, intervals, and definition may be reviewed by an expert panel and/or end users.

While there are many potential approaches for assigning weights to each domain (arbitrarily assignment, or multi-criterion decision analysis), this implementation employs the preferred approach described previously, integrating all domains into a single unifying metric that can then be scored, drawing on core aspects of multi-criterion decision analysis to embed patient preferences.

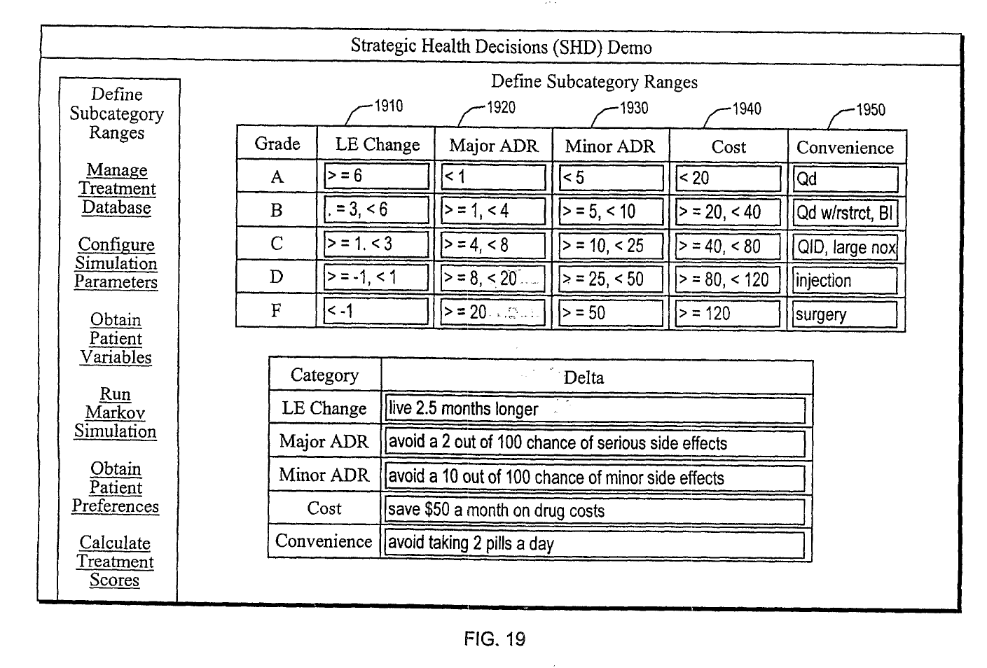

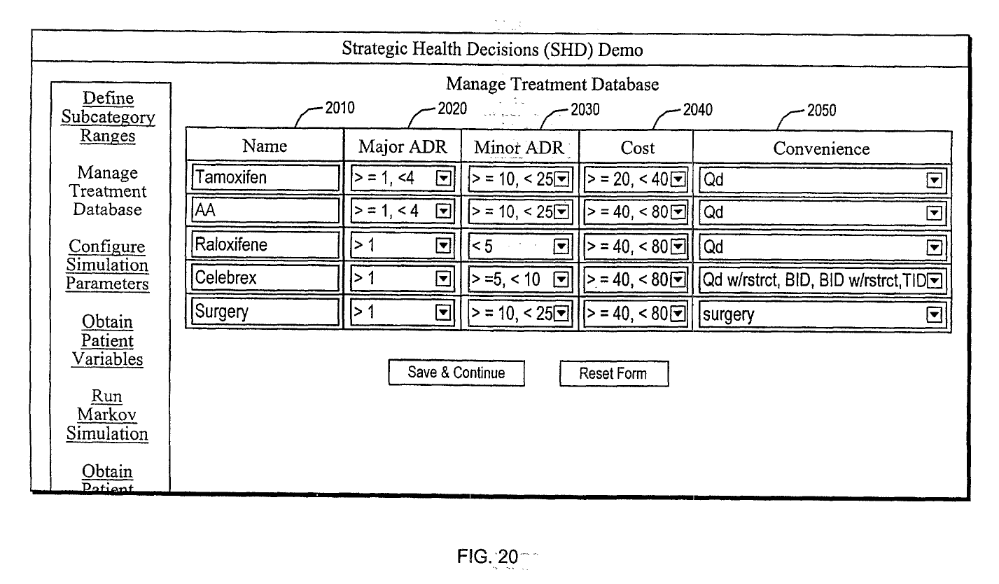

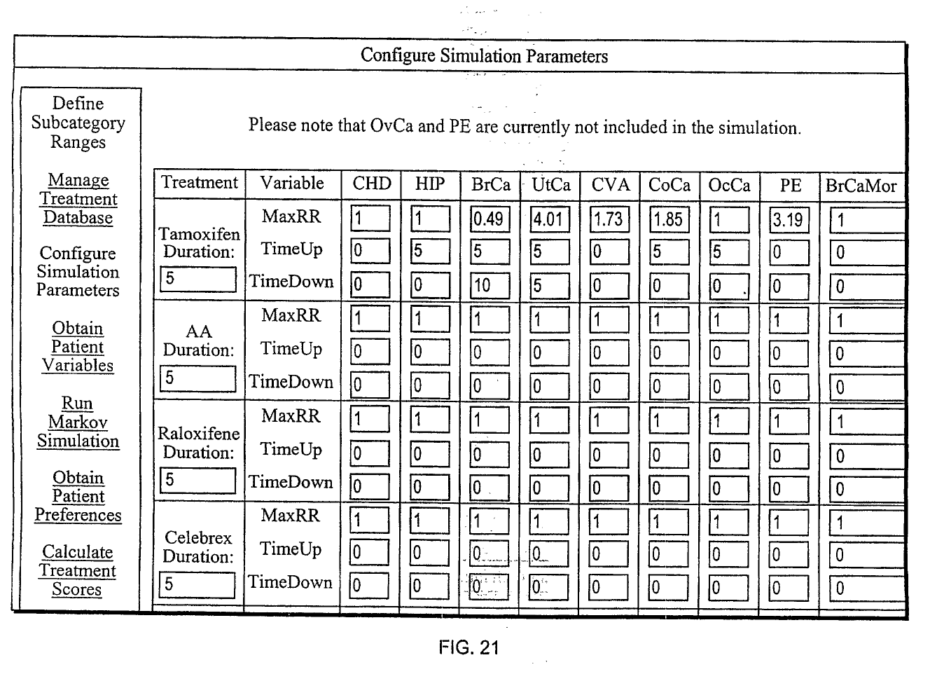

FIG. 19 is a screenshot from this example system implementing the present invention, depicting the interface whereby preferences for life expectancy (LE) 1910 and variables from other domains, including major adverse drug reaction (ADR) 1920, minor ADR 1930, cost 1940, and convenience 1950, are defined in order to generate an overall treatment score. FIG. 20 is another screenshot from this example system, depicting the interface whereby the available treatment options 2010 may be managed with respect to major ADR 2020, minor ADR 2030, cost 2040, and convenience 2050. FIG. 21 depicts the interface in this example system whereby the various simulation parameters may be configured.

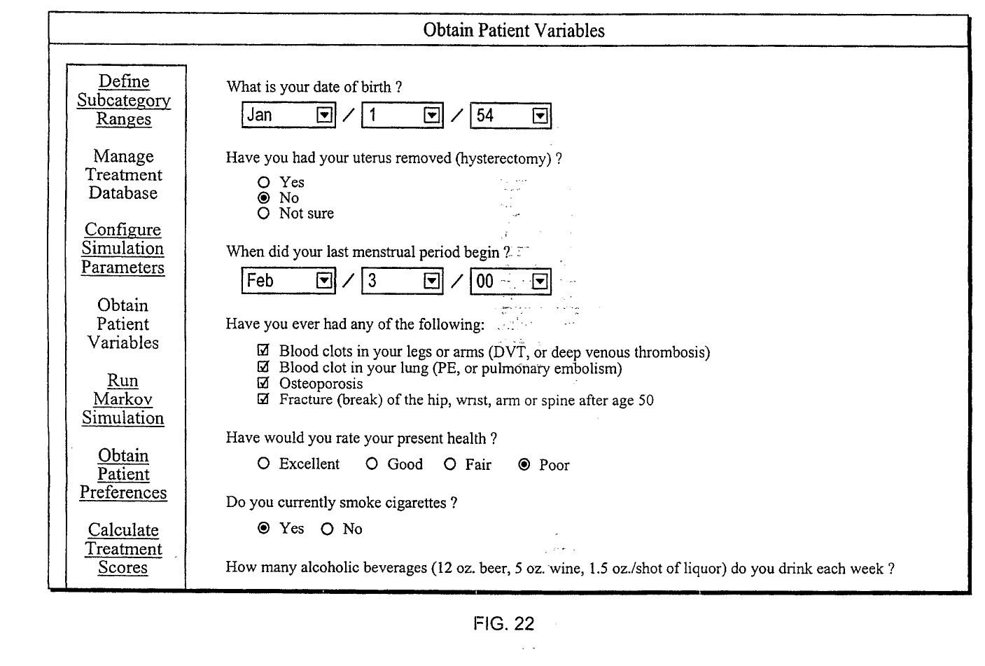

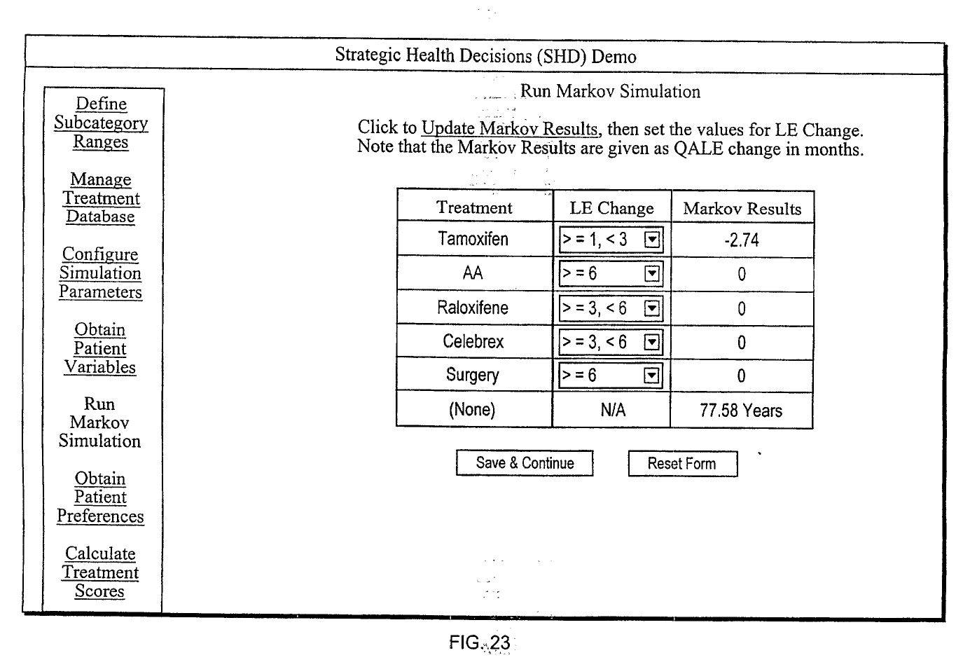

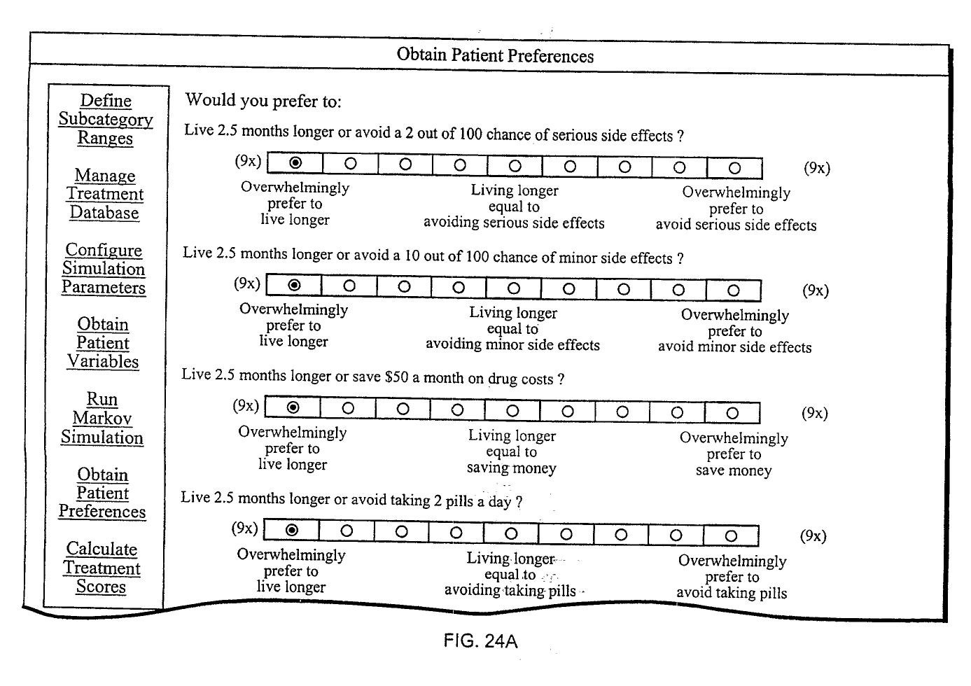

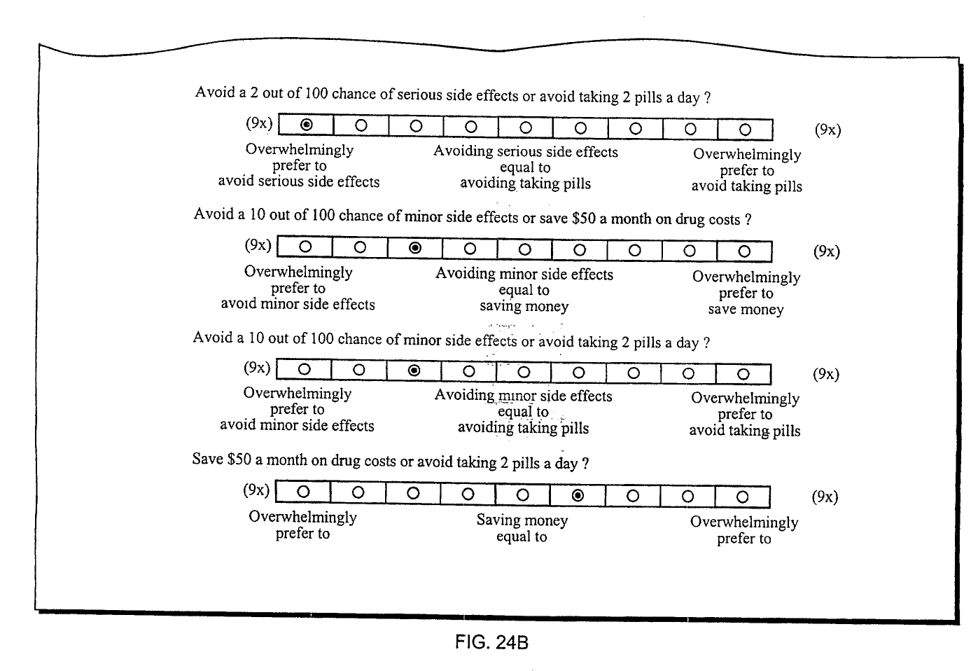

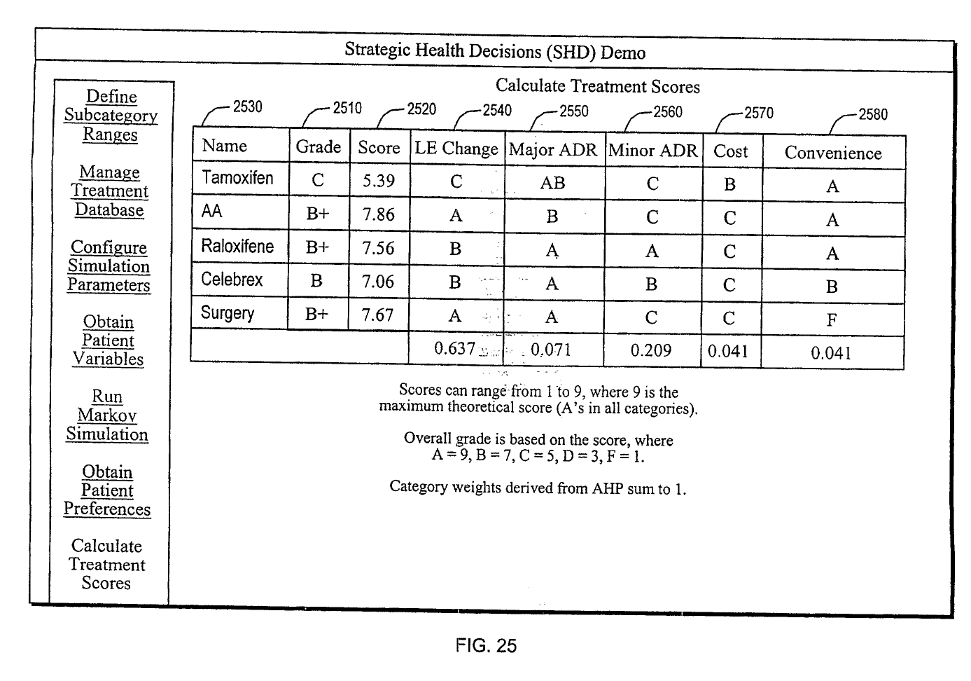

FIG. 22 is another screenshot from this example system, depicting the interface whereby various patient variables may be entered. The screenshot of FIG. 23 depicts the interface whereby the Markov simulation is run. FIGS. 24A and B are the two parts of another screenshot, depicting the interface whereby various patient preferences are solicited. FIG. 25 depicts the interface whereby the final treatment grades 2510 and scores 2520 are provided to the user for each treatment option 2530. Besides overall grades 2510 for the treatment option, individual grades are provided for LE change 2540, major ADR 2550, minor ADR 2560, cost 2570, and convenience 2580.

The operative source code for this example implementation is included on the accompanying compact disc, previously incorporated by reference. The files included and their functions are:

| | |
|---|---|
| default.asp | The main program that presents the user interface. |
| dInfo.pm | Provides disease-specific equations. |
| markov.pl | The Markov simulation code, called by default.asp. |
| mTable.pl | Hard-coded tables used by dInfo.pm. |

The embodiment also utilizes a standard SQL server database and a directory of image files containing graphics used on the web site, both of which are well known devices that are easily used and implemented by anyone of ordinary skill in the art of the present invention.

In one embodiment of the present invention, additional options for sensitivity analysis are utilized with the method. In a preferred embodiment, a simplified user-interface is provided so that patients can set the input variables themselves and predict their own life expectancies and quality-adjusted life expectancies. They can also view the cumulative risks of developing or dying from various outcomes, with and with specific treatments or specific risk factors (i.e., if they were to quit smoking). The present invention is specifically designed to be applied to a particular subset of the many problems that can be solved with decision trees, a subset that arises very frequently in medical decision-making. While the present invention has been described in relation to medical decision-making applications, the methodology may also be used for other applications, including any application where traditional decision tree methodology is employed or applicable, decision-making under conditions of uncertainty, or when different preference-sensitive domains need to be considered and combined to assist with decision making. The model assumes that diseases act independently and that the state probabilities at time t are only dependent on those at time t−1, which assumptions are also commonly used with decision trees. Although the method handles large numbers of diseases far more efficiently than decision trees, it still requires an exponential amount of time and memory with respect to the number of diseases.

The apparatus and method of the present invention therefore provide a technique for modeling decisions involving multiple clinical outcomes by modeling the impact of a treatment on a simulated cohort as a Markov process that eliminates the need for decision trees by replacing them with a single transition matrix that can be used to directly update the state probabilities at each iteration in the simulation. The present invention, based on matrix algebra, has several advantages over decision trees: defining the model is far easier and less error-prone, bias due to the order in which diseases are considered is eliminated, no combination states are excluded, the algorithm is very efficient and can handle a large number of diseases, assumptions such as quality-of-life estimates and discount rates can be changed without running the entire simulation multiple times, implementation through a web-based interface can permit a user to adjust both model-specific and patient-specific variables, and integration of multiple distinct domains according to patient or other end-user preferences is enabled.

While the present invention has been described in terms of specific embodiments, each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications and substitutions by one of ordinary skill in the art are therefore also considered to be within the scope of the present invention, which is not to be limited except by the claims that follow.

What is claimed is:

1. A method for evaluating the effect of a selected treatment option on a specific patient, comprising the steps of:
creating at least one disease risk prediction model for the specific patient;
defining a set of health states having initial probabilities;
formulating a transition matrix based on the disease risk prediction model and the set of health states;
using the transition matrix, performing matrix calculation to obtain an output matrix;
if additional cycles are needed, performing the steps of:
updating the transition matrix; and
using the updated transition matrix, performing matrix calculation to update the output matrix; and
utilizing the output matrix, deriving at least one derived value related to the effect of the treatment option.

2. The method of claim 1, further comprising the steps of:
combining, to obtain a raw score, at least two values selected from the group consisting of derived values related to the effect of the treatment option, values from the output matrix, and numeric scores from other treatment choice-related domains; and
utilizing the raw score, obtaining a patient-specific score for the selected treatment option.

3. The method of claim 2, further comprising the step of comparing the patient-specific score for the selected treatment option to at least one patient-specific score for another treatment option.

4. The method of claim 1, further comprising the step of obtaining at least one model-specific, disease-specific, treatment-specific, or user-specific parameter from a user.

5. The method of claim 1, further comprising the step of providing at least one derived value related to the effect of the treatment option to a user through an interactive user interface.

6. The method of claim 1, wherein the derived value is selected from the group consisting of life expectancy (LE), quality-adjusted life expectancy (QALE), cumulative disease-specific incidence or mortality, LE with a discount rate, and QALE with a discount rate.

7. The method of claim 2, wherein the step of combining utilizes at least one numeric score from other treatment choice-related domains that is selected from the group consisting of major treatment side-effects, minor treatment side-effects, convenience of dosing, route of dosing, costs, ethical concerns, health beliefs, religious beliefs, and long-term consequences of treatment.

8. The method of claim 2, the step of combining comprising the steps of:
assigning weights to each domain;
weighting each value according to its domain; and
combining the weighted values from each domain.

9. The method of claim 8, the step of assigning weights to each domain comprising the step of pair-wise comparing increments of gains or losses in one domain to incremental gains or losses in each other domain using a common preference scale.

10. A method for evaluating the effect of a selected treatment option on a specific patient, comprising the steps of:
combining, to obtain a raw score, at least two values selected from the group consisting of treatment option-related values derived through modeling techniques, calculated values derived from the treatment option-related values, and numeric scores from other treatment choice-related domains; and
utilizing the raw score, obtaining a patient-specific score for the selected treatment option.

11. The method of claim 10, further comprising the step of comparing the patient-specific score for the selected treatment option to at least one patient-specific score for another treatment option.

12. The method of claim 10, wherein at least one treatment option-related value derived through modeling techniques is obtained through the steps of:
creating at least one disease risk prediction model for the specific patient;
defining a set of health states having initial probabilities;
formulating a transition matrix based on the disease risk prediction model and the set of health states;
using the transition matrix, performing matrix calculation to obtain an output matrix comprising at least one treatment option-related value; and
if additional cycles are needed, performing the steps of:
updating the transition matrix; and
using the updated transition matrix, performing matrix calculation to update the output matrix.

13. The method of claim 12, further comprising the step of utilizing the output matrix in deriving at least one calculated value derived from the treatment option-related values.

14. The method of claim 10, further comprising the step of providing at least one patient-specific score to a user through an interactive user interface.

15. The method of claim 10, wherein the step of combining utilizes at least one numeric score from other treatment choice-related domains that is selected from the group consisting of major treatment side-effects, minor treatment side-effects, convenience of dosing, route of dosing, costs, ethical concerns, health beliefs, religious beliefs, and long-term consequences of treatment.

16. The method of claim 17, the step of combining comprising the steps of:
assigning weights to each domain;
weighting each value according to its domain; and
combining the weighted values from each domain.

17. The method of claim 16, the step of assigning weights to each domain comprising the step of pair-wise comparing increments of gains or losses in one domain to incremental gains or losses in each other domain using a common preference scale.

18. A computer-readable medium, the medium being characterized in that:
the computer-readable medium contains code that, when executed in a processor, implements a method for evaluating the effect of a selected treatment option on a specific patient by performing the steps of:
creating at least one disease risk prediction model for the specific patient;
defining a set of health states having initial probabilities;
formulating a transition matrix based on the disease risk prediction model and the set of health states;
using the transition matrix, performing matrix calculation to obtain an output matrix;
if additional cycles are needed, performing the steps of:
updating the transition matrix; and
using the updated transition matrix, performing matrix calculation to update the output matrix; and
utilizing the output matrix, deriving at least one derived value related to the effect of the treatment option.

19. The computer-readable medium of claim 18, the medium being characterized in that:
the computer-readable medium further containing code that, when executed in a processor, performs the steps of:
combining, to obtain a raw score, at least two values selected from the group consisting of derived values related to the effect of the treatment option, values from the output matrix, and numeric scores from other treatment choice-related domains; and
utilizing the raw score, obtaining a patient-specific score for the selected treatment option.

20. The computer-readable medium of claim 19, the medium being characterized in that:
the computer-readable medium further containing code that, when executed in a processor, performs the step of comparing the patient-specific score for the selected treatment option to at least one patient-specific score for another treatment option.

21. The computer-readable medium of claim 18, the medium being characterized in that:
the computer-readable medium further containing code that, when executed in a processor, performs the step of obtaining at least one model-specific, disease-specific, treatment-specific, or user-specific parameter from a user.

22. The computer-readable medium of claim 18, the medium being characterized in that:
the computer-readable medium further containing code that, when executed in a processor, performs the step of providing at least one derived value related to the effect of the treatment option to a user through an interactive user interface.

23. The computer-readable medium of claim 18, wherein the derived value is selected from the group consisting of life expectancy (LE), quality-adjusted life expectancy (QALE), cumulative disease-specific incidence or mortality, LE with a discount rate, and QALE with a discount rate.

24. The computer-readable medium of claim 19, wherein the step of combining utilizes at least one preference value from treatment choice-related domains selected from the group consisting of major treatment side-effects, minor treatment side-effects, convenience of dosing, route of dosing, costs, ethical concerns, health beliefs, religious beliefs, and long-term consequences of treatment.

25. The computer-readable medium of claim 19, the medium being characterized in that:
the computer-readable medium further containing code that, when executed in a processor, performs the step of combining by the steps of:
assigning weights to each domain;
weighting each value according to its domain; and
combining the weighted values from each domain.

26. The computer-readable medium of claim 25, the medium being characterized in that:
the computer-readable medium further containing code that, when executed in a processor, performs the step of assigning weights by the step of pair-wise comparing increments of gains or losses in one domain to incremental gains or losses in each other domain using a common preference scale.

27. A computer-readable medium, the medium being characterized in that:
the computer-readable medium contains code that, when executed in a processor, implements a method for evaluating the effect of a selected treatment option on a specific patient by performing the steps of:
combining, to obtain a raw score, at least two values selected from the group consisting of treatment option-related values derived through modeling techniques, calculated values derived from the treatment option-related values, and numeric scores from other treatment choice-related domains; and
utilizing the raw score, obtaining a patient-specific score for the selected treatment option.

28. The computer-readable medium of claim 27, the medium being characterized in that:
the computer-readable medium further containing code that, when executed in a processor, performs the step of comparing the patient-specific score for the selected treatment option to at least one patient-specific score for another treatment option.

29. The computer-readable medium of claim 27, the medium being characterized in that:
the computer-readable medium further containing code that, when executed in a processor, performs the step of obtaining at least one treatment option-related value derived through modeling techniques by the steps of:
creating at least one disease risk prediction model for the specific patient;
defining a set of health states having initial probabilities;
formulating a transition matrix based on the disease risk prediction model and the set of health states;
using the transition matrix, performing matrix calculation to obtain an output matrix comprising at least one treatment option-related value; and
if additional cycles are needed, performing the steps of:
updating the transition matrix; and
using the updated transition matrix, performing matrix calculation to update the output matrix.

30. The computer-readable medium of claim 29, the medium being characterized in that:
the computer-readable medium further containing code that, when executed in a processor, performs the step of utilizing the output matrix in deriving at least one calculated value derived from the treatment option-related values.

31. The computer-readable medium of claim 27, the medium being characterized in that:
the computer-readable medium further containing code that, when executed in a processor, performs the step of providing at least one patient-specific score to a user through an interactive user interface.

32. The computer-readable medium of claim 27, wherein the step of combining utilizes at least one preference value from treatment choice-related domains selected from the group consisting of major treatment side-effects, minor treatment side-effects, convenience of dosing, route of dosing, costs, ethical concerns, health beliefs, religious beliefs, and long-term consequences of treatment.

33. The computer-readable medium of claim 27, the medium being characterized in that:
the computer-readable medium further containing code that, when executed in a processor, performs the step of combining by the steps of:
assigning weights to each domain;
weighting each value according to its domain; and
combining the weighted values from each domain.

34. The computer-readable medium of claim 33, the medium being characterized in that:
the computer-readable medium further containing code that, when executed in a processor, performs the step of assigning weights by the step of pair-wise comparing increments of gains or losses in one domain to incremental gains or losses in each other domain using a common preference scale.
